(19) United States
(12) Patent Application Publication
(10) Pub. No.: US 2019/0270054 A1
(43) Pub. Date: Sep. 5, 2019

(54) GAS SEPARATION MEMBRANES COMPRISING CROSSLINKED CELLULOSE ESTERS

(71) Applicant: Eastman Chemical Company, Kingsport, TN (US)

(72) Inventors: Jos Simon De Wit, Kingsport, TN (US); SM Bedarul Islam, Kingsport, TN (US); Krishnan Iyer, Johnson City, TN (US); James Thomas Goetz, Kingsport, TN (US); Jacob Donald Goodrich, Johnson City, TN (US); Leslie Shane Moody, Johnson City, TN (US); Jeffrey Todd Owens, Kingsport, TN (US); Devin G. Barrett, Jonesborough, TN (US)

(73) Assignee: Eastman Chemical Company, Kingsport, TN (US)

(21) Appl. No.: 16/319,837

(22) PCT Filed: Jul. 25, 2017
(86) PCT No.: PCT/US2017/043590

§ 371 Date: Jan. 23, 2019

Related U.S. Application Data
(60) Provisional application No. 62/367,891, filed on Jul. 28, 2016.

(51) Int. Cl. B01D 71/16; B01D 69/08; B01D 53/22; B01D 69/02; B01D 69/06; B01D 67/00; C08B 1/00; C08B 3/06

(52) U.S. Cl. CPC B01D 71/16; B01D 69/08; B01D 53/228; B01D 69/02; B01D 69/06; B01D 67/0006; B01D 2053/224; C08B 3/06; B01D 2325/34; B01D 2325/022; B01D 2323/30; B01D 2323/36; C08B 1/003

(57) ABSTRACT

This patent application discloses membranes comprised of cellulose esters that are crosslinked. The membrane can be in the form of a flat film, tube or hollow fiber membrane. The membranes are plasticization resistant and can be used to separate gases.

### BACKGROUND OF THE INVENTION

Synthetic polymer membranes are used to separate gases. However, there is a need for membranes that can separate gases in the oil and gas industry that are plasticization resistant. The present application discloses plasticization resistant crosslinked membranes made from celluloses esters that are useful for separating gases.

### BRIEF SUMMARY OF THE INVENTION

This patent application discloses a membrane comprising:

(a) a cellulose ester comprising:
(i) a plurality of an (C₂₋₂₀)alkanoyl substituent;
(ii) a plurality of a crosslinkable substituent; and
(iii) a plurality of hydroxyl groups,
wherein the degree of substitution of the (C₂₋₂₀)alkanoyl substituent (“DS_{Ak}”) is in the range of from about 0 to about 2.8,
wherein the degree of substitution of the crosslinkable substituent (“DS_{CS}”) is in the range of from about 0.01 to about 2.0,
wherein the degree of substitution of the hydroxyl substituent (“DS_{OH}”) is in the range of from about 0.1 to about 1.0, and
wherein the cellulose ester has a number average molecular weight (“Mₙ”) in the range of from about 5,000 Da to about 110,000 Da; and

wherein the membrane comprises at least some crosslinks.

The patent application also discloses methods for making the membranes.

### BRIEF DESCRIPTION OF THE SEVERAL VIEWS OF THE DRAWINGS

FIG. 1 is plot of the standard downstream and upstream pressures as a function of time collected during a CVVP test.

### DETAILED DESCRIPTION OF THE INVENTION

Current polymeric membrane materials have reached a limit in their productivity-selectivity trade-off relationship for separations. In addition, gas separation processes based on glassy solution-diffusion membranes frequently suffer from plasticization of the stiff polymer matrix by the sorbed condensable penetrant molecules such as CO₂. Plasticization of the polymer represented by the membrane structure swelling and significant increase in the permeabilities of all components in the feed occurs above the plasticization pressure when the feed gas mixture contains condensable gases.

For example, for cellulose acetate (CA) membrane, the high solubility of CO₂ swells the polymer to such an extent that intermolecular interactions are disrupted. As a result, mobility of the acetyl and hydroxyl pendant groups, as well as small-scale main chain motions, would increase thereby enhancing the gas transport rates. See Puleo, et ah, J. Membr. Sci., 47: 301 (1989). This result indicates a strong need to develop new plasticization-resistant membrane materials. The markets for membrane processes could be expanded considerably through the development of robust, high plasticization-resistant membrane materials. However, no effective method has been invented in the literature to reduce the plasticization of CA membrane so far.

Conventional methods for stabilizing the polymeric membranes against plasticization are either annealing or crosslinking. Polymeric membrane crosslinking methods include thermal treatment, radiation, chemical crosslinking, UV-photochemical, blending with other polymers, etc. See Koros, et al, US 20030221559 (2003); Jorgensen, et al., US 2004261616 (2004); Wind, et al., Macromolecules, 36: 1882 (2003); Patel, et al., Adv. Func. Mater., 14 (7): 699 (2004); Patel, et al., Macromol. Chem. Phy., 205: 2409 (2004).

This invention pertains to high plasticization-resistant chemically crosslinked cellulose ester membranes. This invention also pertains to methods for making these high plasticization-resistant chemically crosslinked cellulose ester membranes.

This invention also pertains to the applications of these crosslinked cellulose ester membranes not only for a variety of gas separations such as separations of CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃/mixtures with CH₄, N₂, H₂, and other light gases separations, but also for liquid separations such as desalination and pervaporations.

One major goal of this work is to reduce undesirable effects caused by condensable gases such as CO₂ and propylene (C₃H₆) induced plasticization (swelling) of cellulose ester membranes for gas separations. The cellulose ester membranes described in this application can be prepared by reacting crosslinkable substituents capable of forming intermolecular crosslinks to the cellulose esters and/or by reacting two or more cellulose ester chains with auxiliary crosslinking agents capable of forming intermolecular crosslinks. These crosslinked cellulose ester membranes containing covalently interpolymer-chain-connected crosslinked networks can effectively reduce or stop the swelling of the polymers induced by condensable gases to such an extent that intermolecular interactions cannot be disrupted.

As a result, the mobility of the polymer main chain can significantly decrease and thereby enhancing the stability of polymeric membrane against plasticization. The design of a successful crosslinked cellulose ester membranes described herein is based on the proper selection of the cellulose ester and the auxiliary crosslinking agent.

The crosslinked cellulose ester membranes can be used in any convenient form such as sheets, tubes or hollow fibers. The polymeric membrane material provides a wide range of properties important for membrane separations such as low cost, high selectivity, and easy processability.

### Definitions

As used herein, the terms “a,” “an,” and “said” means one or more.

“Alkanoyl Substituent” means a compound of the general formula —C(O)alkyl. The alkyl group can be linear or branched. If the number of carbon units is included (i.e., (C₂₋₅)), the carbon number includes the number of carbon units inclusive of the carbon of the carbonyl group. For example, (C₂₋₃)alkanoyl includes acetyl and propanoyl. Nonlimiting examples of alkanoyl substituents include acetyl, propionyl, or butyryl.

The term “alkyl” means a branched or unbranched saturated hydrocarbon group, such as methyl, n-propyl, isopropyl, n-butyl, isobutyl, n-pentyl, isopentyl, and the like. The carbon units can be included with alkyl (i.e., (C₁₋₅)).

A weight percent (wt. %) of a component, unless specifically stated to the contrary, is based on the total weight of the formulation or composition in which the component is included.

The term “degree of substitution” or “DS” is the average number of a particular substituent (i.e., alkanoyl or hydroxyl) per anhydroglucose in the cellulose ester polymer. Whenever appropriate, a substrate indicating the specific substituent is included (i.e., DS_{OH} or DS_{Ac}).

The terms “containing,” “contains,” and “contain” have the same open-ended meaning as “comprising,” “comprises,” and “comprise” provided above.

“Crosslinkable Substituent” is a moiety that may be chemically attached to the cellulose ester and is capable of forming a bond with another crosslinkable substituent on other cellulose ester molecules, is capable of forming a bond with another crosslinkable substituent on the same cellulose ester molecule, or is capable of forming a bond with another crosslinkable substituent on an auxiliary crosslinker. The crosslinkable substituents may be moieties that comprise alkenyl or alkynyl groups. The crosslinkable substituents may be moieties that comprise thiols. The crosslinkable substituents may be moieties that react with alkenyl or alkynyl groups to form a chemical bond. Nonlimiting examples of crosslinkable substituents include maleate ester (for example, from maleic anhydride), crotonate ester (for example, from crotonic acid), 10-undecenoate ester (for example, from 10-undecenoyl chloride), 3-mercaptopropionate ester (from 3-mercaptopropionic acid), itaconate ester, fumarate ester, alpha-methyl styrene (for example, from 3-isopropenyl-alpha, alpha-dimethylbenzyl isocyanate).

“Auxiliary Crosslinker” is a non-cellulose ester chemical compound that comprises one or more crosslinkable substituents, with crosslinkable substituent being defined as above. The auxiliary crosslinker may be a small molecule, an oligomer, or a polymer. In addition to forming bonds with crosslinkable cellulose ester molecules, the auxiliary crosslinker may react with itself or with other auxiliary crosslinkers. The nature and amount of auxiliary crosslinker may be varied to modulate the membrane properties, such as, but not limited to permeability, separation, solubility, flux, and sorption. This tunability allows for more custom tailoring of membrane to feedstock. Nonlimiting examples of auxiliary crosslinkers include 2-(2-ethoxyethoxy)ethylacrylate, diethylene glycol diacrylate, triethylene glycol diacrylate, tetraethylene glycol diacrylate, triethylene glycol divinyl ether, 1,3,5-triallyl-1,3,5-triazine-2,4,6(1H,3H,5H)-trione, 2,4,6-triallyloxy-1,3,5-triazine, 2,2′-(ethylenedioxy)diethanethiol, hexa(ethylene glycol) dithiol, trimethylolpropane tris(3-mercaptopropionate), 1,2-ethanedithiol, 1,3-propanedithiol, pentaerythritol tetrakis(3-mercaptopropionate), 2,2′-thiodiethanethiol, poly(ethylene glycol) dithiol (1000), poly(ethylene glycol) dithiol (1500), 1,12 dodecanediol dimethacrylate, 1,3-butylene glycol diacrylate, 1,3-butylene glycol dimethacrylate, 1,4-butanediol diacrylate, 1,4-butanediol dimethacrylate, 1,6 hexanediol diacrylate, 1,6 hexanediol dimethacrylate, alkoxylated hexanediol diacrylate, alkoxylated hexanediol diacrylate, alkoxylated neopentyl glycol diacrylate, cyclohexane dimethanol diacrylate, cyclohexane dimethanol dimethacrylate, diethylene glycol dimethacrylate, dipropylene glycol diacrylate, dipropylene glycol diacrylate, ethoxylated (10) bisphenol A diacrylate, ethoxylated (2) bisphenol A dimethacrylate, ethoxylated (3) bisphenol A diacrylate, ethoxylated (30) bisphenol A diacrylate, ethoxylated (30) bisphenol A dimethacrylate, ethoxylated (4) bisphenol A diacrylate, ethoxylated (4) bisphenol A dimethacrylate, ethoxylated (8) bisphenol A dimethacrylate, ethoxylated bisphenol A dimethacrylate, ethoxylated bisphenol A dimethacrylate, ethoxylated (10) bisphenol A dimethacrylate, ethoxylated (6) bisphenol A dimethacrylate, ethylene glycol dimethacrylate, neopentyl glycol diacrylate, neopentyl glycol dimethacrylate, polyethylene glycol (200) diacrylate, polyethylene glycol (400) diacrylate, polyethylene glycol (600) diacrylate, polyethylene glycol (600) dimethacrylate, polyethylene glycol dimethacrylate, polyethylene glycol dimethacrylate, polypropylene glycol (400) dimethacrylate, propoxylated (2) neopentyl glycol diacrylate, tetraethylene glycol diacrylate, tetraethylene glycol dimethacrylate, tricyclodecane dimethanol diacrylate, triethylene glycol diacrylate, triethylene glycol dimethacrylate, tripropylene glycol diacrylate, tripropylene glycol diacrylate.

“Number Average Molecular Weight” or number average molecular mass is the ordinary arithmetic mean or average of the molecular masses of the individual macromolecules. It is determined by measuring the molecular mass of n polymer molecules, summing the masses, and dividing by n. The number average molecular mass of a polymer can be determined by gel permeation chromatography, viscosmetry, vapor pressure osmometry and other methods.

“Asymmetric Membrane consists of a number of layers, each with different structures and permeabilities. A typical anisotropic asymmetric membrane has a relatively dense, thin surface layer (often called the “skin” supported on an open, much thicker porous substructure. The asymmetric membrane can be formed from a single polymer or a blend of polymers.

“Symmetric Membrane” is a membrane that is consistent throughout and made from one layer and could be a dense film or fiber.

Thin layer composite (TLC) or thin layer film (TLF) membranes are made from individually controlled layers such as a woven or non-woven polyester fiber layer (backing) on which a porous polysulfone is cast followed by a polyimide that is interfacially polymerized. In such system each individual step and layer can be optimized.

“Include,” “Includes,” “Including,” “having,” “has,” and “have” have the same open-ended meaning as “comprise,” “comprises,” and “comprising.”

“Glass transition temperature” or “T_{g}” refers to the temperature below which the polymer becomes rigid and brittle, and can crack and shatter under stress.

“Comprise,” “comprises,” and “comprising” are open-ended transition terms used to transition from a subject recited before the term to one or more elements recited after the term are not necessarily the only elements that make up the subject.

As used herein the term “chosen from” when used with “and” or “or” have the following meanings: A variable chosen from A, B and C means that the variable can be A alone, B alone, or C alone. A variable A, B, or C means that the variable can be A alone, B alone, C alone, A and B in combination, A and C in combination, or A, B, and C in combination.

Additional definitions can be found throughout the Specification.

### Membranes

This patent application discloses a membrane comprising: (a) a cellulose ester comprising: (i) a plurality of an (C₂₋₂₀)alkanoyl substituent; (ii) a plurality of a crosslinkable substituent; and (iii) a plurality of hydroxyl groups, wherein the degree of substitution of the (C₂₋₂₀)alkanoyl substituent (“DS_{Ak}”) is in the range of from about 0 to about 2.8, wherein the degree of substitution of the crosslinkable substituent (“DS_{CS}”) is in the range of from about 0.01 to about 2.0, wherein the degree of substitution of the hydroxyl substituent (“DS_{OH}”) is in the range of from about 0.1 to about 1.0, and wherein the cellulose ester has a number average molecular weight (“Mₙ”) in the range of from about 5,000 Da to about 110,000 Da, wherein the membrane comprises at least some covalent crosslinks.

In one embodiment, the membrane is crosslinked via radiation, thermal treatment, or chemical crosslinking. In one class of this embodiment, the radiation is ultraviolet radiation. In one class of this embodiment, the crosslinked membrane is crosslinked via radiation. In one class of this embodiment, the crosslinked membrane is crosslinked via thermal treatment.

In one class of this embodiment, the crosslinked membrane is crosslinked via thermal treatment.

In one embodiment, the membrane is a symmetric membrane. In one embodiment, membrane is an asymmetric membrane.

In one embodiment, the membrane is a hollow fiber membrane. In one class of this embodiment, the hollow fiber membrane is asymmetric. In one class of this embodiment, the asymmetric layer comprises a skin layer.

In one embodiment, the membrane is a flat sheet. In one class of this embodiment, the flat sheet membrane is spiral wound.

In one embodiment, the (C₂₋₂₀)alkanoyl substituent is chosen from acetyl, propionyl, n-butyryl, isobutyryl, pivaloyl, 2-methylbutanoyl, 3-methylbutanoyl, pentanoyl, 2-methylpentanoyl, 3-methylpentanoyl, 4-methylpentanoyl, hexanoyl, palmitoyl, lauryl, decanoyl, undecanoyl, or a fatty acid derived substituent. In one embodiment, the (C₂₋₂₀)alkanoyl substituent is chosen from acetyl, propionyl, or n-butyryl. In one embodiment, the (C₂₋₂₀)alkanoyl substituent is chosen from acetyl or propionyl. In one embodiment, the (C₂₋₂₀)alkanoyl substituent is acetyl. In one embodiment, the (C₂₋₂₀)alkanoyl substituent is propionyl. In one embodiment, the (C₂₋₂₀)alkanoyl is branched. In one embodiment, the (C₂₋₂₀)alkanoyl substituents is normal.

In one embodiment, the crosslinkable substituent comprises 1-2 of an alkenyl, an alkynyl, a thiol, or an acrylate group. In one class of this embodiment, the crosslinkable substituent is chosen from maleate, crotonate, 2-(3-(prop-1-en-2-yl)phenyl)propan-2-yl)carbamoate, undec-10-enoate, hex-5-enoate, hept-6-enoate, oct-7-enoate, non-8-enoate, dec-9-enoate, or dodec-11-enoate. In one subclass of this class, the DS_{CS} is from about 0.2 to about 0.5. In one subclass of this class, the crosslinkable substituent is undec-10-enoate. In one sub-subclass of this subclass, the DS_{CS} is from about 0.2 to about 0.5.

In one embodiment, the crosslinkable substituent is chosen from an (C₂₋₂₀)alkenoyl or an (C₂₋₂₀)alkynoyl. In one class of this embodiment, the DS_{CS} is from about 0.2 to about 0.5. In one embodiment, the crosslinkable substituent is chosen from maleate, crotonate, 2-(3-(prop-1-en-2-yl)phenyl)propan-2-yl)carbamoate, undec-10-enoate, hex-5-enoate, hept-6-enoate, oct-7-enoate, non-8-enoate, dec-9-enoate, or dodec-11-enoate. In one embodiment, the crosslinkable substituent is chosen from maleate, crotonate, 2-(3-(prop-1-en-2-yl)phenyl)propan-2-yl)carbamoate, or undecenoate. In one embodiment, the crosslinkable substituent is maleate. In one embodiment, the crosslinkable substituent is crotonate. In one embodiment, the crosslinkable substituent is 2-(3-(prop-1-en-2-yl)phenyl)propan-2-yl)carbamoate. In one embodiment, the crosslinkable substituent is undec-10-enoate. In one embodiment, the crosslinkable substituent is an (C₆₋₂₀)alkenoyl. In one embodiment, the crosslinkable substituent is an (C₆₋₂₀)alkynoyl. In one embodiment, the crosslinkable substituent is an (C₆₋₁₂)alkenoyl. In one embodiment, the crosslinkable substituent is an (C₆₋₁₂)alkynoyl.

In one embodiment, the membrane further comprises (b) an auxiliary crosslinker, wherein the auxiliary crosslinker is present from about 0.01 to about 50.0 wt % based on the total weight of the crosslinkable cellulose ester and the auxiliary crosslinker. In one class of this embodiment, the auxiliary crosslinker is present from about 1 to about 2 wt % based on the total weight of the crosslinkable cellulose ester and the auxiliary crosslinker. In one class of this embodiment, the auxiliary crosslinker is present from about 2 to about 3 wt % based on the total weight of the crosslinkable cellulose ester and the auxiliary crosslinker. In one class of this embodiment, the auxiliary crosslinker is present from about 3 to about 4 wt % based on the total weight of the crosslinkable cellulose ester and the auxiliary crosslinker. In one class of this embodiment, the auxiliary crosslinker is present from about 5 to about 10 wt % based on the total weight of the crosslinkable cellulose ester and the auxiliary crosslinker. In one class of this embodiment, the auxiliary crosslinker is present from about 10 to about 15 wt % based on the total weight of the crosslinkable cellulose ester and the auxiliary crosslinker. In one class of this embodiment, the auxiliary crosslinker is present from about 15 to about 20 wt % based on the total weight of the crosslinkable cellulose ester and the auxiliary crosslinker. In one class of this embodiment, the auxiliary crosslinker is present from about 20 to about 25 wt % based on the total weight of the crosslinkable cellulose ester and the auxiliary crosslinker. In one class of this embodiment, the auxiliary crosslinker is present from about 5 to about 15 wt % based on the total weight of the crosslinkable cellulose ester and the auxiliary crosslinker. In one class of this embodiment, the auxiliary crosslinker is present from about 15 to about 25 wt % based on the total weight of the crosslinkable cellulose ester and the auxiliary crosslinker.

In each of the previously described classes for this embodiment, the auxiliary crosslinker comprises an alkenyl, an alkynyl, a thiol, or an acrylate group. In each of the previously described classes for this embodiment, the auxiliary crosslinker comprises an alkenyl or an alkynyl group. In each of the previously described classes for this embodiment, the auxiliary crosslinker comprises a thiol group. In each of the previously described classes for this embodiment, the auxiliary crosslinker comprises an acrylate group.

In each of the previously described classes for this embodiment, the auxiliary crosslinker is chosen from 2-(2-ethoxyethoxy)ethylacrylate, triethylene glycol diacrylate, tetraethylene glycol diacrylate, poly(C10)ethylene glycol diacrylate, or 3,6-Dioxa-1,8-octane-dithiol for this embodiment. In each of the previously described classes for this embodiment, the auxiliary crosslinker is 2-(2-ethoxyethoxy)ethylacrylate. In each of the previously described classes for this embodiment, the auxiliary crosslinker is triethylene glycol diacrylate. In each of the previously described classes for this embodiment, the auxiliary crosslinker is tetraethylene glycol diacrylate. In each of the previously described classes for this embodiment, the auxiliary crosslinker is poly(C10)ethylene glycol diacrylate. In each of the previously described classes, the auxiliary crosslinker is 3,6-Dioxa-1,8-octane-dithiol.

In one class of this embodiment, the auxiliary crosslinker comprises an alkenyl, an alkynyl, a thiol, or an acrylate group. In one subclass of this class, the auxiliary crosslinker comprises an alkenyl or an alkynyl group. In one subclass of this class, the auxiliary crosslinker comprises a thiol group. In one subclass of this class, the auxiliary crosslinker comprises an acrylate group.

In one subclass of this class, the auxiliary crosslinker is chosen from 2-(2-ethoxyethoxy)ethylacrylate, triethylene glycol diacrylate, tetraethylene glycol diacrylate, or poly(C10)ethylene glycol diacrylate. In one subclass of this class, the auxiliary crosslinker is 2-(2-ethoxyethoxy)ethylacrylate. In one subclass of this class, the auxiliary crosslinker is triethylene glycol diacrylate.

In one class of this embodiment, the auxiliary crosslinker is tetraethylene glycol diacrylate. In one subclass of this class, the auxiliary crosslinker is poly(C10)ethylene glycol diacrylate.

In one class of this embodiment, the auxiliary crosslinker is

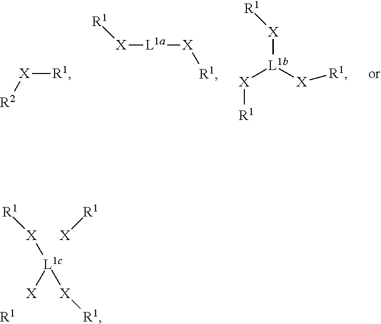

wherein each R¹ is independently

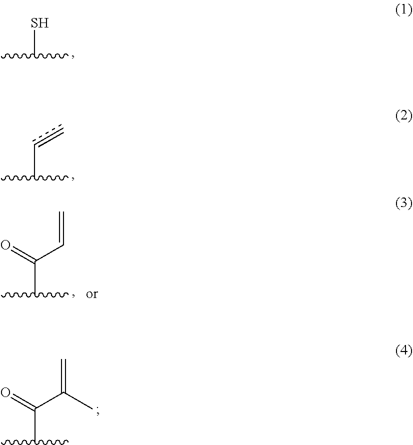

R² is (1) (C₁₋₂₀)alkyl, (2) R⁵—[—O—(C₁₋₆)alkyl-O-]ₙ—, wherein n is 0-2000, and wherein R⁵ is hydrogen or (C₁₋₃)alkyl; each X is independently absent, —O—, or —OCH₂—; L^{1a} is (1) —O—(C₁₋₂₀)alkyl-O—, (2) —[—O—(C₁₋₆)alkyl-O—]ₙ—, wherein n is 0-2000, (3)

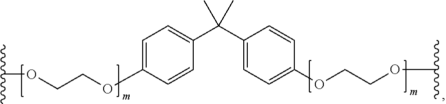

wherein each m is independently 0-100; L^{1b} is

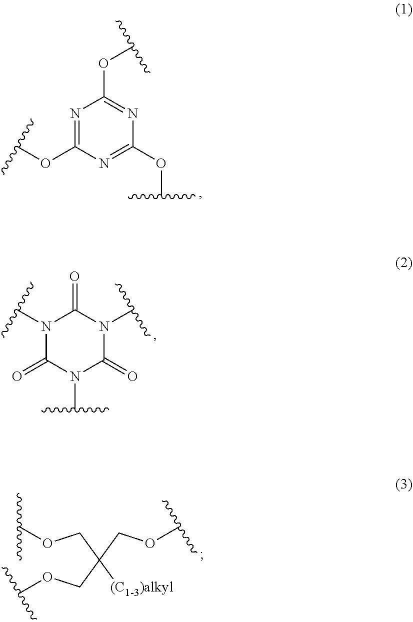

### and L^{1c} is

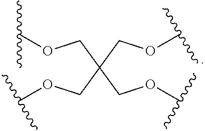 [SMILES: *OCC(CO*)(CO*)CO* ; "."]

In one subclass of this class, the auxiliary crosslinker is

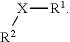

In one sub-subclass of this subclass, R¹ is

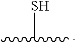 [SMILES: *S ; "."]

In one sub-sub-subclass of this sub-subclass, R² is (C₁₋₂₀)alkyl. In one sub-sub-sub-subclass of this sub-sub-subclass, each X is absent. In one sub-sub-sub-subclass of this sub-subclass, each X is —O—. In one sub-sub-subclass of this sub-sub-subclass, each X is —OCH₂—.

In one sub-sub-subclass of this sub-subclass, R² is R⁵—[—O—(C₁₋₆)alkyl-O—]ₙ—, wherein n is 0-2000, and wherein R⁵ is hydrogen or (C₁₋₃)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-subclass of this subclass, R¹ is

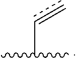 [SMILES: *C=C ; "."]

In one sub-sub-subclass of this sub-subclass, R² is (C₁₋₂₀)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, R² is R⁵—[—O—(C₁₋₆)alkyl-O—]ₙ—, wherein n is 0-2000, and wherein R⁵ is hydrogen or (C₁₋₃)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-subclass of this subclass, R¹ is

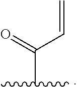 [SMILES: *C(=O)C=C ; "."]

In one sub-sub-subclass of this sub-subclass, R² is (C₁₋₂₀)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, R² is R⁵—[—O—(C₁₋₆)alkyl-O—]ₙ—, wherein n is 0-2000, and wherein R⁵ is hydrogen or (C₁₋₃)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-subclass of this subclass, R¹ is

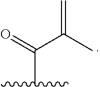 [SMILES: *C(=O)C(=C)C ; "."]

In one sub-sub-subclass of this sub-subclass, R² is (C₁₋₂₀)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, R² is R⁵—[—O—(C₁₋₆)alkyl-O—]ₙ—, wherein n is 0-2000, and wherein R⁵ is hydrogen or (C₁₋₃)alkyl. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one subclass of this class, the auxiliary crosslinker is

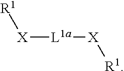

In one sub-subclass of this subclass, R¹ is

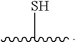 [SMILES: *S ; "."]

In one sub-sub-subclass of this sub-subclass, L^{1a} is —O—(C₁₋₂₀)alkyl-O—. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is —[—O—(C₁₋₆)alkyl-O—]ₙ—, wherein n is 0-2000. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is

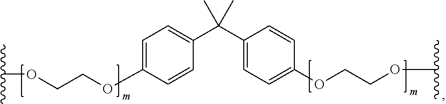

wherein each m is independently 0-100. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one subclass of this class, R¹ is

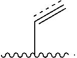 [SMILES: *C=C ; "."]

In one sub-subclass of this subclass, L^{1a} is —O—(C₁₋₂₀)alkyl-O In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is L^{1a} is —[—O—(C₁-6)alkyl-O—]ₙ—, wherein n is 0-2000. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is

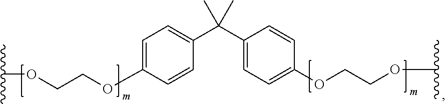

wherein each m is independently 0-100. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one subclass of this class, R¹ is

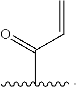 [SMILES: *C(=O)C=C ; "."]

In one sub-sub-subclass of this sub-subclass, L^{1a} is L^{1a} is —O—(C₁₋₂₀)alkyl-O—. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is L^{1a} is —[—O—(C₁₋₆)alkyl-O—]ₙ—, wherein n is 0-2000. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is

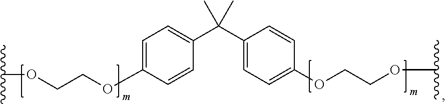

wherein each m is independently 0-100. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one subclass of this class, R¹ is

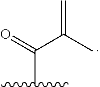 [SMILES: *C(=O)C(=C)C ; "."]

In one sub-sub-subclass of this sub-subclass, L^{1a} is L^{1a} is —O—(C₁₋₂₀)alkyl-O—. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is L^{1a} is —[—O—(C₁₋₆)alkyl-O—]ₙ—, wherein n is 0-2000. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1a} is

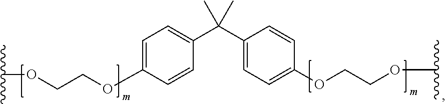

wherein each m is independently 0-100. In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one subclass of this class, the auxiliary crosslinker is

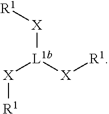

In one sub-subclass of this subclass, R¹ is

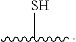 [SMILES: *S ; "."]

In one sub-sub-subclass of this sub-subclass, L^{1a} is L^{1b} is

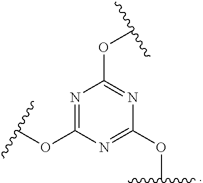 [SMILES: *Oc1nc(O*)nc(O*)n1 ; "."]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this subclass, L^{1b} is

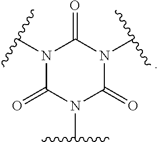 [SMILES: *n1c(=O)n(*)c(=O)n(*)c1=O ; "."]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

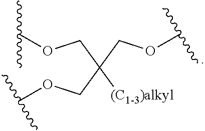

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-subclass of this sub-class, R¹ is

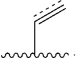 [SMILES: *C=C ; "."]

In one sub-sub-subclass of this sub-subclass, L^{1b} is

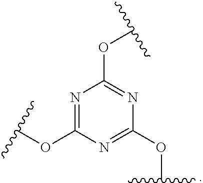 [SMILES: *Oc1nc(O*)nc(O*)n1 ; "."]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

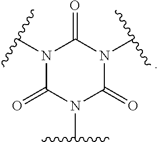 [SMILES: *n1c(=O)n(*)c(=O)n(*)c1=O ; "."]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

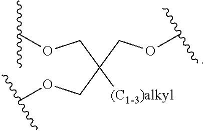

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-subclass of this subclass, R¹ is

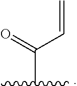 [SMILES: *C(=O)C=C ; "."]

In one sub-sub-subclass of this sub-subclass, L^{1b} is

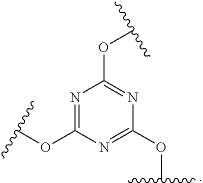 [SMILES: *Oc1nc(O*)nc(O*)n1 ; "."]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

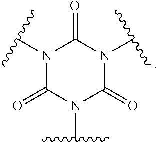 [SMILES: *n1c(=O)n(*)c(=O)n(*)c1=O ; "."]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

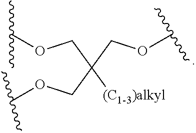

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-subclass of this subclass, R¹ is

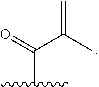 [SMILES: *C(=O)C(=C)C]

In one sub-sub-subclass of this sub-subclass, L^{1b} is

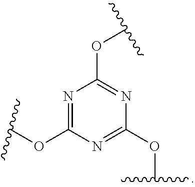 [SMILES: *Oc1nc(O*)nc(O*)n1]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

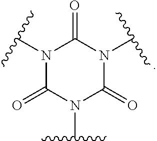 [SMILES: *n1c(=O)n(*)c(=O)n(*)c1=O]

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one sub-sub-subclass of this sub-subclass, L^{1b} is

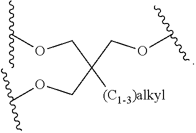

In one sub-sub-sub-subclass of this sub-sub-subclass, each X is absent. In one sub-subclass of this subclass, each X is —O—. In one sub-sub-sub-subclass of this sub-sub-subclass, each X is —OCH₂—.

In one subclass of this class, the auxiliary crosslinker is

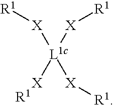

In one sub-subclass of this subclass, R¹ is

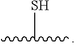 [SMILES: *S]

In one sub-sub-subclass of this sub-subclass, each X is absent. In one sub-sub-subclass of this sub-subclass, each X is —O—. In one sub-sub-subclass of this sub-subclass, each X is —OCH₂—.

In one sub-subclass of this subclass, R¹ is

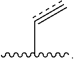

In one sub-sub-subclass of this sub-subclass, each X is absent. In one sub-sub-subclass of this sub-subclass, each X is —O—. In one sub-sub-subclass of this sub-subclass, each X is —OCH₂—.

In one sub-subclass of this subclass, R¹ is

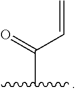 [SMILES: *C(=O)C=C]

In one sub-sub-subclass of this sub-subclass, each X is absent. In one sub-sub-subclass of this sub-subclass, each X is —O—. In one sub-sub-subclass of this sub-subclass, each X is —OCH₂—.

In one sub-subclass of this subclass, R¹ is

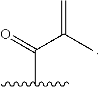 [SMILES: *C(=O)C(=C)C]

In one sub-sub-subclass of this sub-subclass, each X is absent. In one sub-sub-subclass of this sub-subclass, each X is —O—. In one sub-sub-subclass of this sub-subclass, each X is —OCH₂—.

In one embodiment, the DS_{Ak} is in the range of from about 2.0 to about 2.8. In one embodiment, the DS_{Ak} is in the range of from about 2.5 to about 2.8. In one embodiment, the DS_{Ak} is in the range of from about 1.5 to about 2.0.

In one embodiment, the DS_{OH} is in the range of from about 0.5 to about 1.0. In one embodiment, the DS_{OH} is in the range of from about 0.8 to about 1.0. In one embodiment, the DS_{OH} is in the range of from about 0.5 to about 0.8.

In one embodiment, the DS_{CS} is in the range of from about 0.05 to about 1.0. In one embodiment, the DS_{CS} is in the range of from about 0.01 to about 0.5. In one embodiment, the DS_{CS} is in the range of from about 0.5 to about 1.0. In one embodiment, the DS_{CS} is in the range of from about 0.2 to about 0.5.

In one embodiment, the Mₙ is in the range of from about 20,000 Da to about 60,000 Da. In one embodiment, the Mₙ is in the range of from about 5,000 Da to about 20,000 Da. In one embodiment, the Mₙ is in the range of from about 60,000 Da to about 80,000 Da.

In one embodiment, the P(CO₂) is in the range of from about 6 barrer to about 15 barrer at 35° C. In one embodiment, the P(CO₂) is in the range of from about 10 barrer to about 15 barrer at 35° C.

In one embodiment, the membrane has a pure gas carbon dioxide permeability (“P(CO₂)”) in the range of from about 2 barrer to about 200 barrer measured at 50° C. In one class of this embodiment, the membrane has a pure gas P(CO₂) in the range of from about 2 barrer to about 100 barrer. In one class of this embodiment, the membrane has a pure gas P(CO₂) in the range of from about 50 barrer to about 200 barrer. In one class of this embodiment, the membrane has a pure gas P(CO₂) in the range of from about 100 barrer to about 200 barrer. In one class of this embodiment, the membrane has a pure gas P(CO₂) in the range of from about 150 barrer to about 200 barrer.

In one embodiment, the membrane has a pure gas nitrogen permeability (“P(N2)”) or a pure gas methane permeability (“P(CH₄)”) in the range of from about 0.01 barrer to about 20 barrer measured at 50° C. In one class of this embodiment, the membrane has a pure gas nitrogen permeability (“P(N₂)”) or a pure gas methane permeability (“P(CH₄)”) in the range of from about 1 barrer to about 20 barrer measured at 50° C. In one class of this embodiment, the membrane has a pure gas nitrogen permeability (“P(N₂)”) or a pure gas methane permeability (“P(CH₄)”) in the range of from about 5 barrer to about 20 barrer measured at 50° C. In one class of this embodiment, the membrane has a pure gas nitrogen permeability (“P(N₂)”) or a pure gas methane permeability (“P(CH₄)”) in the range of from about 0.01 barrer to about 15 barrer measured at 50° C. In one class of this embodiment, the membrane has a pure gas nitrogen permeability (“P(N₂)”) or a pure gas methane permeability (“P(CH₄)”) in the range of from about 0.01 barrer to about 10 barrer measured at 50° C. In one class of this embodiment, the membrane has a pure gas nitrogen permeability (“P(N₂)”) or a pure gas methane permeability (“P(CH₄)”) in the range of from about 1 barrer to about 10 barrer measured at 50° C. In one class of this embodiment, the membrane has a pure gas nitrogen permeability (“P(N₂)”) or a pure gas methane permeability (“P(CH₄)”) less than 20 barrer measured at 50° C. In one class of this embodiment, the membrane has a pure gas nitrogen permeability (“P(N₂)”) or a pure gas methane permeability (“P(CH₄)”) less than 10 barrer measured at 50° C. In one class of this embodiment, the membrane has a pure gas nitrogen permeability (“P(N₂)”) or a pure gas methane permeability (“P(CH₄)”) less than 5 barrer measured at 50° C. In one class of this embodiment, the membrane has a pure gas nitrogen permeability (“P(N₂)”) or a pure gas methane permeability (“P(CH₄)”) less than 2 barrer measured at 50° C. In one class of this embodiment, the membrane has a pure gas nitrogen permeability (“P(N₂)”) or a pure gas methane permeability (“P(CH₄)”) less than 1 barrer measured at 50° C.

In one embodiment, the membrane has a carbon dioxide permeability (“P(CO₂)”) in the range of from about 2 barrer to about 200 barrer and a methane permeability (“P(CH₄)”) less than 100 barrer as measured with a 50:50 carbon dioxide/methane blend at 50° C. In one class of this embodiment, the membrane has a carbon dioxide permeability (“P(CO₂)”) in the range of from about 10 barrer to about 200 barrer and a methane permeability (“P(CH₄)”) less than 100 barrer as measured with a 50:50 carbon dioxide/methane blend at 50° C. In one class of this embodiment, the membrane has a carbon dioxide permeability (“P(CO₂)”) in the range of from about 20 barrer to about 200 barrer and a methane permeability (“P(CH₄)”) less than 100 barrer as measured with a 50:50 carbon dioxide/methane blend at 50° C. In one class of this embodiment, the membrane has a carbon dioxide permeability (“P(CO₂)”) in the range of from about 50 barrer to about 200 barrer and a methane permeability (“P(CH₄)”) less than 100 barrer as measured with a 50:50 carbon dioxide/methane blend at 50° C. In one class of this embodiment, the membrane has a carbon dioxide permeability (“P(CO₂)”) in the range of from about 75 barrer to about 200 barrer and a methane permeability (“P(CH₄)”) less than 100 barrer as measured with a 50:50 carbon dioxide/methane blend at 50° C. In one class of this embodiment, the membrane has a carbon dioxide permeability (“P(CO₂)”) in the range of from about 2 barrer to about 200 barrer and a methane permeability (“P(CH₄)”) less than 50 barrer as measured with a 50:50 carbon dioxide/methane blend at 50° C. In one class of this embodiment, the membrane has a carbon dioxide permeability (“P(CO₂)”) in the range of from about 2 barrer to about 200 barrer and a methane permeability (“P(CH₄)”) less than 25 barrer as measured with a 50:50 carbon dioxide/methane blend at 50° C.

In one embodiment, the membrane when subjected to carbon dioxide at 20 bar and at 5 bar satisfies the following expressions:

$$\frac{( {P ( CO 2 )}_{20 bar} - {P ( CO 2 )}_{5 bar} )}{{P}_{{CO}_{2 , 5 bar}}} * 100 < 50$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane when subjected to carbon dioxide at 20 bar and at 5 bar satisfies the following expressions:

$$\frac{( {P ( CO 2 )}_{20 bar} - {P ( CO 2 )}_{5 bar} )}{{P}_{{CO}_{2 , 5 bar}}} * 100 < 40$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane when subjected to carbon dioxide at 20 bar and at 5 bar satisfies the following expressions:

$$\frac{( {P ( CO 2 )}_{20 bar} - {P ( CO 2 )}_{5 bar} )}{{P}_{{CO}_{2 , 5 bar}}} * 100 < 30$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane when subjected to carbon dioxide at 20 bar and at 5 bar satisfies the following expressions:

$$\frac{( {P ( CO 2 )}_{20 bar} - {P ( CO 2 )}_{5 bar} )}{{P}_{{CO}_{2 , 5 bar}}} * 100 < 25$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane when subjected to carbon dioxide at 20 bar and at 5 satisfies the following expressions:

$$\frac{( {P ( CO 2 )}_{20 bar} - {P ( CO 2 )}_{5 bar} )}{{P}_{{CO}_{2 , 5 bar}}} * 100 < 20$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane when subjected to carbon dioxide at 20 bar and at 5 satisfies the following expressions:

$$\frac{( {P ( CO 2 )}_{20 bar} - {P ( CO 2 )}_{5 bar} )}{{P}_{{CO}_{2 , 5 bar}}} * 100 < 15$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane when subjected to carbon dioxide at 20 bar and at 5 bar satisfies the following expressions:

$$\frac{( {P ( CO 2 )}_{20 bar} - {P ( CO 2 )}_{5 bar} )}{{P}_{{CO}_{2 , 5 bar}}} * 100 < 10$$

P(CO₂)_{20bar}=carbon dioxide permeability at 20 bar measured at 50° C.
P(CO₂)_{5bar}=carbon dioxide permeability at 5 bar measured at 50° C.

In one embodiment, the membrane has a carbon dioxide/nitrogen gas or carbon dioxide/methane selectivity greater than 10 as measured at 50° C. in pure CO₂, N₂ and CH₄ gas streams at 4 bar. In one embodiment, the membrane has a carbon dioxide/nitrogen gas or carbon dioxide/methane selectivity greater than 15 as measured at 50° C. in pure CO₂, N₂ and CH₄ gas streams at 4 bar. In one embodiment, the membrane has a carbon dioxide/nitrogen gas or carbon dioxide/methane selectivity greater than 20 as measured at 50° C. in pure CO₂, N₂ and CH₄ gas streams at 4 bar. In one embodiment, the membrane has a carbon dioxide/nitrogen gas or carbon dioxide/methane selectivity in the range of from about 10 to about 100 as measured at 50° C. in pure CO₂, N₂ and CH₄ gas streams at 4 bar. In one embodiment, the membrane has a carbon dioxide/nitrogen gas or carbon dioxide/methane selectivity in the range of from about 10 to about 50 as measured at 50° C. in pure CO₂, N₂ and CH₄ gas streams at 4 bar. In one embodiment, the membrane has a carbon dioxide/nitrogen gas or carbon dioxide/methane selectivity in the range of from about 20 to about 50 as measured at 50° C. in pure CO₂, N₂ and CH₄ gas streams at 4 bar. In one embodiment, the membrane has a carbon dioxide/nitrogen gas or carbon dioxide/methane selectivity in the range of from about 30 to about 50 as measured at 50° C. in pure CO₂, N₂ and CH₄ gas streams at 4 bar. In one embodiment, the membrane has a carbon dioxide/nitrogen gas or carbon dioxide/methane selectivity in the range of from about 40 to about 50 as measured at 50° C. in pure CO₂, N₂ and CH₄ gas streams at 4 bar.

In one embodiment, the membrane has a carbon dioxide/nitrogen gas selectivity greater than 10 as measured at 50° C. in pure nitrogen gas stream of 20 bar and a pure carbon dioxide gas stream of 5 bar. In one embodiment, the membrane has a carbon dioxide/nitrogen gas selectivity greater than 15 as measured at 50° C. in pure nitrogen gas stream of 20 bar and a pure carbon dioxide gas stream of 5 bar. In one embodiment, the membrane has a carbon dioxide/nitrogen gas selectivity greater than 20 as measured at 50° C. in pure nitrogen gas stream of 20 bar and a pure carbon dioxide gas stream of 5 bar.

In one embodiment, the membrane has a carbon dioxide/nitrogen gas selectivity in the range of from about 10 to about 100 as measured at 50° C. in pure nitrogen gas stream of 20 bar and a pure carbon dioxide gas stream of 5 bar. In one embodiment, the membrane has a carbon dioxide/nitrogen gas selectivity in the range of from about 10 to about 75 as measured at 50° C. in pure nitrogen gas stream of 20 bar and a pure carbon dioxide gas stream of 5 bar. In one embodiment, the membrane has a carbon dioxide/nitrogen gas selectivity in the range of from about 20 to about 50 as measured at 50° C. in pure nitrogen gas stream of 20 bar and a pure carbon dioxide gas stream of 5 bar. In one embodiment, the membrane has a carbon dioxide/nitrogen gas selectivity in the range of from about 20 to about 100 as measured at 50° C. in pure nitrogen gas stream of 20 bar and a pure carbon dioxide gas stream of 5 bar. In one embodiment, the membrane has a carbon dioxide/nitrogen gas selectivity in the range of from about 30 to about 100 as measured at 50° C. in pure nitrogen gas stream of 20 bar and a pure carbon dioxide gas stream of 5 bar. In one embodiment, the membrane has a carbon dioxide/nitrogen gas selectivity in the range of from about 30 to about 50 as measured at 50° C. in pure nitrogen gas stream of 20 bar and a pure carbon dioxide gas stream of 5 bar. In one embodiment, the membrane has a carbon dioxide/nitrogen gas selectivity in the range of from about 30 to about 40 as measured at 50° C. in pure nitrogen gas stream of 20 bar and a pure carbon dioxide gas stream of 5 bar.

In one embodiment, the membrane has a carbon dioxide/methane selectivity greater than 10 as measured at 50° C. in a 50:50 mixed gas stream of carbon dioxide/methane at 4 bar. In one embodiment, the membrane has a carbon dioxide/methane selectivity greater than 20 as measured at 50° C. in a 50:50 mixed gas stream of carbon dioxide/methane at 4 bar. In one embodiment, the membrane has a carbon dioxide/methane selectivity greater than 30 as measured at 50° C. in a 50:50 mixed gas stream of carbon dioxide/methane at 4 bar. In one embodiment, the membrane has a carbon dioxide/methane selectivity greater than 40 as measured at 50° C. in a 50:50 mixed gas stream of carbon dioxide/methane at 4 bar. In one embodiment, the membrane has a carbon dioxide/methane selectivity in the range of from about 10 to about 100 as measured at 50° C. in a 50:50 mixed gas stream of carbon dioxide/methane at 4 bar. In one embodiment, the membrane has a carbon dioxide/methane selectivity in the range of from about 10 to about 75 as measured at 50° C. in a 50:50 mixed gas stream of carbon dioxide/methane at 4 bar. In one embodiment, the membrane has a carbon dioxide/methane selectivity in the range of from about 10 to about 50 as measured at 50° C. in a 50:50 mixed gas stream of carbon dioxide/methane at 4 bar. In one embodiment, the membrane has a carbon dioxide/methane selectivity in the range of from about 10 to about 40 as measured at 50° C. in a 50:50 mixed gas stream of carbon dioxide/methane at 4 bar. In one embodiment, the membrane has a carbon dioxide/methane selectivity in the range of from about 10 to about 30 as measured at 50° C. in a 50:50 mixed gas stream of carbon dioxide/methane at 4 bar. In one embodiment, the membrane has a carbon dioxide/methane selectivity in the range of from about 20 to about 100 as measured at 50° C. in a 50:50 mixed gas stream of carbon dioxide/methane at 4 bar. In one embodiment, the membrane has a carbon dioxide/methane selectivity in the range of from about 30 to about 100 as measured at 50° C. in a 50:50 mixed gas stream of carbon dioxide/methane at 4 bar. In one embodiment, the membrane has a carbon dioxide/methane selectivity in the range of from about 40 to about 100 as measured at 50° C. in a 50:50 mixed gas stream of carbon dioxide/methane at 4 bar. In one embodiment, the membrane has a carbon dioxide/methane selectivity in the range of from about 20 to about 50 as measured at 50° C. in a 50:50 mixed gas stream of carbon dioxide/methane at 4 bar. In one embodiment, the membrane has a carbon dioxide/methane selectivity in the range of from about 20 to about 40 as measured at 50° C. in a 50:50 mixed gas stream of carbon dioxide/methane at 4 bar.

In one embodiment, the membrane has a carbon dioxide/methane selectivity greater than 9 as measured at 50° C. in a 50:50 mixed gas stream of carbon dioxide/methane at 40 bar. In one embodiment, the membrane has a carbon dioxide/methane selectivity greater than 10 as measured at 50° C. in a 50:50 mixed gas stream of carbon dioxide/methane at 40 bar. In one embodiment, the membrane has a carbon dioxide/methane selectivity greater than 15 as measured at 50° C. in a 50:50 mixed gas stream of carbon dioxide/methane at 40 bar. In one embodiment, the membrane has a carbon dioxide/methane selectivity greater than 20 as measured at 50° C. in a 50:50 mixed gas stream of carbon dioxide/methane at 40 bar. In one embodiment, the membrane has a carbon dioxide/methane selectivity greater than 30 as measured at 50° C. in a 50:50 mixed gas stream of carbon dioxide/methane at 40 bar. In one embodiment, the membrane has a carbon dioxide/methane selectivity greater than 40 as measured at 50° C. in a 50:50 mixed gas stream of carbon dioxide/methane at 40 bar.

In one embodiment, the membrane has a carbon dioxide/methane selectivity in the range of from about 9 to about 100 as measured at 50° C. in a 50:50 mixed gas stream of carbon dioxide/methane at 40 bar. In one embodiment, the membrane has a carbon dioxide/methane selectivity in the range of from about 10 to about 100 as measured at 50° C. in a 50:50 mixed gas stream of carbon dioxide/methane at 40 bar. In one embodiment, the membrane has a carbon dioxide/methane selectivity in the range of from about 10 to about 75 as measured at 50° C. in a 50:50 mixed gas stream of carbon dioxide/methane at 40 bar. In one embodiment, the membrane has a carbon dioxide/methane selectivity in the range of from about 10 to about 50 as measured at 50° C. in a 50:50 mixed gas stream of carbon dioxide/methane at 40 bar. In one embodiment, the membrane has a carbon dioxide/methane selectivity in the range of from about 10 to about 40 as measured at 50° C. in a 50:50 mixed gas stream of carbon dioxide/methane at 40 bar. In one embodiment, the membrane has a carbon dioxide/methane selectivity in the range of from about 10 to about 30 as measured at 50° C. in a 50:50 mixed gas stream of carbon dioxide/methane at 40 bar. In one embodiment, the membrane has a carbon dioxide/methane selectivity in the range of from about 20 to about 100 as measured at 50° C. in a 50:50 mixed gas stream of carbon dioxide/methane at 40 bar. In one embodiment, the membrane has a carbon dioxide/methane selectivity in the range of from about 30 to about 100 as measured at 50° C. in a 50:50 mixed gas stream of carbon dioxide/methane at 40 bar. In one embodiment, the membrane has a carbon dioxide/methane selectivity in the range of from about 40 to about 100 as measured at 50° C. in a 50:50 mixed gas stream of carbon dioxide/methane at 40 bar. In one embodiment, the membrane has a carbon dioxide/methane selectivity in the range of from about 20 to about 50 as measured at 50° C. in a 50:50 mixed gas stream of carbon dioxide/methane at 40 bar. In one embodiment, the membrane has a carbon dioxide/methane selectivity in the range of from about 20 to about 40 as measured at 50° C. in a 50:50 mixed gas stream of carbon dioxide/methane at 40 bar.

### Methods

The present application discloses a method for the preparation of a crosslinked membrane comprising (1) preparing a membrane from a composition comprising a crosslinkable cellulose ester comprising: (i) a plurality of an (C₂₋₂₀)alkanoyl substituent; (ii) a plurality of a crosslinkable substituent; and (iii) a plurality of hydroxyl groups, wherein the degree of substitution of the (C₂₋₂₀)alkanoyl substituent (“DS_{Ak}”) is in the range of from about 0 to about 2.8, wherein the degree of substitution of the crosslinkable substituent (“DS_{CS}”) is in the range of from about 0.01 to about 2.0, wherein the degree of substitution of the hydroxyl substituent (“DS_{OH}”) is in the range of from about 0.1 to about 1.0, and wherein the cellulose ester has a number average molecular weight (“Mₙ”) in the range from about 5,000 Da to about 110,000 Da; and (2) exposing at least a portion of the membrane to radiation, thermal treatment, or chemical crosslinking to form of crosslinks.

In one embodiment, the composition further comprises an auxiliary crosslinker, wherein the auxiliary crosslinker is present from about 0.01 to about 50.0 wt % based on the total weight of the crosslinkable cellulose ester and the auxiliary crosslinker. Examples of auxiliary crosslinkers have been previously described.

In one embodiment, the membrane is subjected to radiation. In one class of this embodiment, the radiation is ultraviolet radiation. In one embodiment, the membrane is subjected to a thermal treatment. In one embodiment, the membrane is subjected to a chemical crosslinking agent.

In one embodiment, the membrane is a sheet, a tube, or a hollow fiber membrane. In one class of this embodiment, the membrane is a sheet. In one class of this embodiment, the membrane is a tube. In one class of this embodiment, the membrane is a hollow fiber membrane.

Conventional methods for stabilizing the polymeric membranes against plasticization are either annealing or crosslinking. Polymeric membrane crosslinking methods include thermal treatment, radiation, chemical crosslinking, UV-photochemical, blending with other polymers, etc. See Koros, et al, US 20030221559 (2003); Jorgensen, et al., US 2004261616 (2004); Wind, et al., Macromolecules, 36: 1882 (2003); Patel, et al., Adv. Func. Mater., 14 (7): 699 (2004); Patel, et al., Macromol. Chem. Phy., 205: 2409 (2004).

In one embodiment, the method further comprises (3) drying the crosslinked membrane.

### Experimental Section

The invention can be further illustrated by the following examples, although it will be understood that these examples of specific embodiments are included merely for purposes of illustration and are not intended to limit the scope of the invention unless otherwise specifically indicated.

### Abbreviations

Ac₂O is acetic anhydride; AcOH is acetic acid; AMS is 3-Isopropenyl-α, α-dimethylbenzyl Carbamate; AMS CDA is 3-Isopropenyl-α,α-dimethylbenzyl Carbamate functionalized Eastman™ 394-60S; Aux. Cross. is auxiliary crosslinker; BHT is butylated hydroxytoluene; CDA is Eastman™ 394-60S; ° C. is degrees Celsius; CA is cellulose acetate; CE is cellulose ester; DBTDL is dibutyltin dilaurate; EEEA is 2-(2-ethoxyethoxy)ethylacrylate; DS is degree of substitution; DSC is differential scanning colorimetry; g is gram; GPC is gel permeation chromatography; h is hour; HFM is hollow fiber membrane; 1184 is Irgacure® 184; 1819 is Irgacure® 819; IR is infrared; L is liter; min is minute; mL is milliliter; NMP is N-methyl-2-pyrrolidone; PI or Photo. is photoinitiator; PDI is Polydispersity index; PZR is plasticization resistance; rt is room temperature; RT-FTIR is real-time Fourier-transform infrared; S is selectivity; v:v is volume:volume; TEGDA is triethylene glycol diacrylate; THF is tetrahydrofuran; TMI is 3-isopropenyl-dimethylbenzyl isocyanate; UV is ultraviolet; XL is auxiliary crosslinker; TetraEGDA is tetraethylene glycol diacrylate; P10EGDA is poly(C10)ethylene glycol diacrylate; 2T is 3,6-Dioxa-1,8-octane-dithiol; und is undecanoyl;

### Preparations of Cellulose Acetate Comprising Cross-Linkable Moieties

The approximate DS per anhydroglucose unit (AGU) of the substituents were determined by ¹H NMR analysis ¹H NMR data were usually obtained on a JEOL Model Eclipse-600 NMR spectrometer operating at 600 MHz. The sample tube size was 5 mm, and the sample concentrations were ˜20 mg/mL DMSO-d₆. Each spectrum was nominally recorded at 80° C. using 64 scans with a 15 second pulse delay. One to two drops of trifluoroacetic acid-d were added to each sample to shift residual water from the spectral region of interest. Two references that discuss NMR spectral assignments of cellulose esters, in general, are Macromolecules, 1987, 20, 2750 and Macromolecules, 1991, 24, 3050.

Molecular weight measurements were determined by GPC. GPC was run in NMP unless otherwise indicated. In other cases, THF was used as the solvent. Molecular weights were calculated as either CA absolute molecular weight or polystyrene (PS) equivalent molecular weight.

For GPC analysis performed in NMP, the NMP contained 1 wt % AcOH. The instrumentation consists of an Agilent series 1100 liquid chromatography system. The system components consist of a degasser, an isocratic pump with a flow rate set at 0.8 ml/min, an auto-sampler with an injection volume of 50 μL, a column oven set at 40° C. and a refractive index detector set at 40° C. The column set consists of an Agilent PLgel 10 micron guard (7.5×50 mm) and a Mixed-B (7.5×300 mm) column in series. The sample is prepared by weighing 25 mg into a 2 dram screw cap vial and adding 10 ml of the NMP solvent containing the AcOH. Add a stir bar and 10 microliters of toluene to use as a flow rate marker. Place the sample into a heated stir block set at 40° C. until sample is dissolved. The instrument is calibrated with a series of 14 narrow molecular weight polystyrene standards ranging from 580 to 3,750.00 Da in molecular weight. The software used to control the instrument, collect and process the data is Agilent GPC software version 1.2 build 3182.29519.

For GPC analysis performed THF, the THF is stabilized with 250 ppm BHT. The instrumentation consists of an Agilent series 1100 liquid chromatography system. The system components consist of a degasser, an isocratic pump with a flow rate set at 1.0 mL/min, an auto-sampler with an injection volume of 50 μL, a column oven set at 30° C. and a refractive index detector set at 30° C. The column set consists of an Agilent PLgel 5 micron guard (7.5×50 mm) and a Mixed-C (7.5×300 mm) column and an Oligopore (7.5×300 mm) in series. The sample is prepared by weighing 25 mg into a 2 dram screw cap vial and adding 10 mL of the THF solvent. Add a stir bar and 10 microliters of toluene to use as a flow rate marker. Place the sample into stir block set at ambient temperature until sample is dissolved. The instrument is calibrated with a series of 14 narrow molecular weight polystyrene standards ranging from 580 to 3,750,000 Da in molecular weight. The software used to control the instrument, collect and process the data is Agilent GPC software version 1.2 build 3182.29519.

DSC measurements were determined using TA Instruments Q series calorimeters, scanning from 0-250° C., with a scan rate of 20° C./min.

A Metler IR15 was the instrument used in those cases where the extent of reaction was monitored by IR.

### Example 1: 3-Isopropenyl-α,α-dimethylbenzyl Carbamate Functionalized Cellulose Acetate

Eastman™ CA-394-60S (146 g) and dioxane (˜1800 mL) was stirred at 60° C. in a 2 L jacketed reaction kettle fitted with an overhead stirrer, a Dean/Stark (D/S) trap, and a water cooled condenser, and was provided with a dynamic house nitrogen atmosphere. The jacketing fluid temperature was set to 116° C., which allowed for a mild reflux. The Solvent (˜250 mL) was removed continuously via the D/S trap, which dried the reaction mixture by azeotropic distillation of the adventitious water. The kettle set-point was adjusted to 90° C., and DBTDL (5.75 mL) was added. The IR probe (ReactIR15) was inserted and a reference spectrum was collected. TMI (51.5 g) was added, and the reaction progress was monitored by the disappearance of the isocyanate peak ˜16 h. IR analysis at this point showed that the reaction was essentially complete. After cooling, the dope was precipitated into water at high shear (Omni-Mixer homogenizer) and then collected by filtration. The crude product was bag-washed overnight via a continuous of flush deionized water. The product was filtered, dried over 7 h, and further dried in vacuo at 50° C. overnight. Analytical Results: Elemental Analysis: C, 54.93%, H, 6.2%, N, 1.67%; DS_{OH}=0.2; DS_{Ac}=2.5; DS_{AMS}=0.3; Mₙ=29,439 Da; Mw=88,826; PDI=3.0; Tg=147° C.

### Example 2: Maleate Functionalized Cellulose Acetate

AcOH (800 g) was charged to a 2 L jacketed reaction kettle. The kettle was fitted with an overhead stirrer, a Dean/Stark trap with water cooled condenser, and was provided with a dynamic house nitrogen atmosphere. The jacketing fluid temperature was set to 75° C., and the AcOH was heated with stirring. After reaching the temperature set-point, Eastman™ CA-394-60S (200 g) was added portion-wise with agitation to prevent clumping. More AcOH (300 mL) was added to complete the transfer of the flake. After the flake had completely dissolved, sodium acetate (62.5 g) was added in one portion. Once the sodium acetate was dissolved, maleic anhydride (62.5 g) was added. The reaction mixture was heated for 17 h. After slight cooling, the warm dope was precipitated into water (˜7:1/water:dope, v:v) at high shear (Omni-Mixer homogenizer) and then collected by suction filtration. The crude product was bag-washed with a continuous flush of warm water overnight, dried again on a fritted suction funnel, then further dried in a forced air oven at 60° C. for 2 days. Analytical Results: DS_{Ac}=2.49; DS_{Maleate}=0.12; Mn=39,330 Da; Mw=180,577; Mz=380,978; PDI=4.5; T_{g}=188° C.

### Example 3: Crotonate Functionalized Cellulose Acetate

The reactions were thermally controlled with 3 circulation baths containing water and ethylene glycol (1:1). Cellulose (108.0 g per reaction) was activated sequentially with water and AcOH with enough solvents to submerge the pulp. The activated cellulose (46.1% solids) was added to a 2-L, jacketed resin kettle equipped with an overhead stirrer, followed by AcOH (55 g). After fully assembling the resin kettle, the reactor jacket was cooled to 15° C. Ac₂O (329.4 g), crotonic acid (131.7 g), and sulfuric acid (3.7 g) were combined, mixed until homogeneous, and added to an addition funnel cooled to 15° C. The final solutions AcOH (190.9 g) and H₂O (67.3 g) were prepared and added to addition funnels warmed to 45° C. Once the activate cooled to 17-19° C. and the Ac₂O solution was ˜15° C., the Ac₂O solution was added to the activate. After holding at rt for 30 min, the temperature was increased to 53° C. according to a linear gradient ramp over the course of 40 min. The final solutions were slowly added to the reaction, which was heated to 71° C. and held for 250 min. To end the reaction, a solution of Mg(OAc)₂.4H₂O (7 g), AcOH (84 g), and H₂O (64 g) was added. The reaction was stirred for 20 min, and then the system was allowed to cool to rt. The acid dope was filtered through a coarse-fritted glass funnel containing a layer of glass wool and precipitated into H₂O (6 L). The final product was collected by filtering the precipitation solution, washed overnight with running water, and dried in a vacuum oven set to 60° C. Analytical Results: DS_{Ac}=2.56; DS_{Crotonate}=0.12; DS_{OH}=0.32; Mₙ=37,360; Mw=105,626 Da; T_{g}=181° C.

### Example 4: Undecenoate Functionalized Cellulose Acetate

Eastman™ CA-394-60S (394-60S, 200 g) and dioxane (1100 mL) were charged to a 2 L kettle equipped with a condenser and a Dean-Stark (D/S) apparatus. The mixture was heated at 100° C. under a nitrogen atmosphere with stirring until a complete solution resulted. The jacketing fluid temperature was increased 116.5° C., which allowed for a mild reflux. Solvent (˜125 mL total) was removed continuously via the D/S trap, which dried the reaction mixture by azeotropic distillation of the adventitious water. The temperature was decreased to 10° C. and then a solution of anhydrous pyridine (33 g) and dimethylaminopyridine (1.25 g) in dry dioxane (100 mL) was added. The resulting mixture was stirred for ca 10 min, and then a solution of 10-undecenoyl chloride (84 g) in dry dioxane (150 mL) was slowly added. The solution was stirred at 10° C. for another 2 h, then at 40° C. for an additional 2 h. Heating was discontinued, and the reaction mixture was allowed to stand at rt overnight. The dope was precipitated into water at high shear using a homogenizer and then collected by suction filtration. The crude product was washed on the frit with deionized water (˜6 L) then bag-washed in a water bath overnight. After soaking overnight, the crude product was further bag-washed with a continuous flush of deionized water for ˜5 h. The product was dried again on the frit to remove most of the water, and then further dried in a vacuum oven at 50° C. overnight at ˜25 mmHg with a slight nitrogen sparge. Analytical Results: DS_{Ac}=2.33; DS_{Und}=0.53; DS_{OH}=0.14; Mₙ=34,305 Da; PDI=2.7;

### Example 5: Undecenoate Functionalized Cellulose Acetate Butyrate

Eastman™ CAB-381-20 (100 g) and anhydrous dioxane (410 mL) were charged to a 1 gallon glass reaction vessel and stirred at RT until a complete solution resulted. A solution of anhydrous pyridine (5 g) and dimethylaminopyridine (1 g) in dry dioxane (100 mL) was added. The resulting mixture was stirred for ca 1 h more, and then a solution of 10-undecenoyl chloride (11 g) in dry dioxane (100 mL) was added with fast stirring. The solution was stirred at RT for another 3 d. The dope was precipitated into water at high shear using a homogenizer and then the fine granules were collected in a filter bag. The crude product was washed in the bag with deionized water, then further bag-washed with a continuous flush of deionized water for ca 24 h. The washed product was centrifuged to remove most of the water, and then further dried overnight in a vacuum oven at 50° C. and overnight at ˜25 mm Hg with a slight nitrogen sparge. Analytical Results: DS_{Ac}=1.00; DS_{Und}=0.30; DS_{Bu}=1.67; DS_{OH}=0.03; Mₙ=51,700 Da; PDI=3.4.

### Example 6: Undecenoate Functionalized Cellulose Acetate Propionate

Eastman™ CAP (25 g, 35.5% propionyl, 3% acetyl, and 7.8% hydroxyl) was added with stirring to anhydrous dioxane (90 mL) in a 500 mL round flask. A solution of anhydrous pyridine (5.45 g) and dimethylaminopyridine (240 mg) in dry dioxane (100 mL) was added and the mixture was warmed to about 50° C. and stirred until a complete solution resulted. After cooling to room temperature, a solution of 10-undecenoyl chloride (11.75 g) in dry dioxane (50 mL) was added slowly via an addition funnel with fast stirring. The pyridine hydrochloride soon precipitated from solution. The reaction mixture was allowed to stir at room temperature overnight. The dope was precipitated into deionized water at high shear using a homogenizer and then the fine granules were collected in a filter bag. The crude product was washed in the bag with deionized water, then further bag-washed with a continuous flush of deionized water for ca 24 h. The washed product was centrifuged to remove most of the water, and then further dried overnight in a vacuum oven at 50° C. overnight at ˜25 mm Hg with a slight nitrogen sparge. Analytical Results: DS_{Ac}=0.18; DS_{Und}=0.57; DS_{OH}=0.63; DSₚᵣ=1.62; Mₙ=43,536 Da; PDI=3.2; Tg=120° C.

### Example 7: Undecenoate Functionalized Cellulose Acetate Propionate

Eastman™ CAP (25 g, 35.5% propionyl, 3% acetyl, and 7.8% hydroxyl) was added with stirring to anhydrous dioxane (90 mL) in a 500 mL round flask. A solution of anhydrous pyridine (5.45 g) and dimethylaminopyridine (240 mg) in dry dioxane (100 mL) was added and the mixture was warmed to about 50° C. and stirred until a complete solution resulted. After cooling to room temperature, a solution of 10-undecenoyl chloride (11. g) in dry dioxane (50 mL) was added slowly via an addition funnel with fast stirring. The pyridine hydrochloride soon precipitated from solution. The reaction mixture was allowed to stir at room temperature overnight. The dope was precipitated into deionized water at high shear using a homogenizer and then the fine granules were collected in a filter bag. The crude product was washed in the bag with deionized water, then further bag-washed with a continuous flush of deionized water for ca 24 h. The washed product was centrifuged to remove most of the water, and then further dried overnight in a vacuum oven at 50° C. overnight at ˜25 mm Hg with a slight nitrogen sparge. Analytical Results: DS_{Ac}=0.18; DS_{Und}=1.2; DS_{OH}=0; DSₚᵣ=1.62; Mₙ=43,536 Da; PDI=3.2; T_{g}=120° C.

### Evaluation of Crosslinked Cellulose Esters

### 1. Preparation of Dopes

The cellulose ester polymers were evaluated by making measurements on both films and after making hollow fiber membranes. To make films as well as hollow fiber membranes, formulated polymer solutions were prepared that contained the crosslinkable cellulose ester, solvents, photoinitiators and additional auxiliary substituents (such as acrylates or thiols). The composition of these dopes for the films and hollow fibers membranes differed to some extent due to fact that spinning and phase inversion require different viscosities and solubilities than films formed by evaporation.

The dopes were made in two distinct steps. First the crosslinkable cellulose ester polymer was dissolved in one or more solvents. This polymer-only dope was then used to prepare the final formulations for film casting and fiber spinning.

Stock solutions (e.g., 12 wt % crosslinkable cellulose ester in a solvent (5 wt % NMP in acetone)) was prepared for each crosslinkable cellulose ester that was evaluated.

### 3. Preparation of Film Membranes

### I. Thermoplastic Films (not UV Cured)

Thermoplastic films were prepared by casting the prepared formulated dopes using a 25 mil (635 micron) draw-down bar on a 6 inch wide and 18 inch long glass plate. The dimensions for the films used in this work were 4 inch wide and 15 inch long. films were cast from on a. After the films were cast, the plates were allowed to air dry (1 h), followed by overnight drying at 104° C. The resulting dry but thermoplastic film thickness was around 35 microns.

### II. Crosslinked Films (UV Cured)

The films were crosslinked by passing them through a Fusion Model HP-6 High Power Six-Inch Ultraviolet Lamp System, using a belt speed of 12 ft/min and a power setting of 70% (of 500 Watts) with the “H” bulb to provide a dose of 2.2 J/cm².

### 4. Gas Permeability Studies for Flat Films

### I. Pure Gas Testing

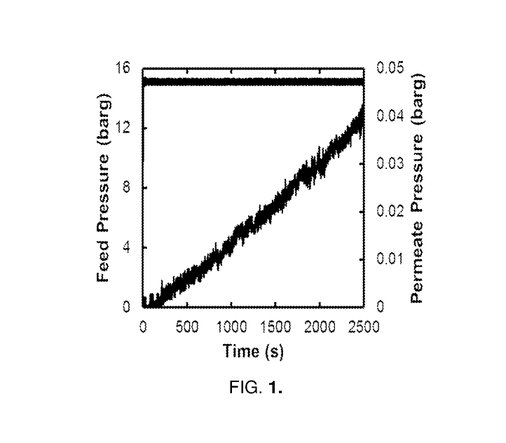

Steady-state gas permeabilities were determined at 35° C. with a constant volume variable pressure (CVVP). The film thickness was measured with a micrometer. CVVP tests are based on the application of high pressure gas to the feed side of a polymeric film and collecting permeate gas in a downstream vessel of a calibrated volume. Prior to the permeation experiments the film and the cells were thoroughly degassed by pulling vacuum on the permeate stream to remove any pre-dissolved gases and to remove air from the feed lines to ensure pure gas testing. After evacuating the instrument, the vacuum pump is turned off and leak rate (dp₂/dt) is determined to measure residual gas pressures within the instrument lines due to pre-existing leaks. A controlled feed pressure applied to the upstream side of the film, while the permeate side is maintained at lower vacuum pressure. The pressure increases slowly on the constant volume permeate side as a function of time which is recorded by a differential pressure transducer. The pressure in the downstream increases slowly and the permeability is calculated from the slope of the steady state pressure increase (see FIG. 1), dp₁/dt in the calibrated volume (V_{d}):

$$P = \frac{{V}_{d} l}{pART} [ \frac{{dp}_{1}}{dt} - \frac{{dp}_{2}}{dt} ] \qquad Equation 2$$

where P is permeability, V_{d} is the calibrated downstream volume, I is the membrane thickness, A is the film area exposed to the permeate gas, R is the gas constant, and T is the absolute temperature. The permeate pressure is typically small with respect to the feed pressure; therefore, the driving force is assumed to equal to the feed pressure. The permeability is usually expressed in units of Barrer, while permeance reported in units of gas permeance unit (GPU):

$$1 Barrer = \frac{{10}^{- 10} {cm}^{3} ( STP ) cm}{{cm}^{2} s cmHg}$$

$$1 GPU = \frac{{10}^{- 6} {cm}^{3} ( STP )}{{cm}^{2} s cmHg}$$

### II. Mixed Gas Testing

Mixed gas permeation experiments are performed in a similar manner compared to single-gas experiments using a 50%/50% CO₂/CH₄ gas mixture. In every gas separation measurement two separate measurements are made simultaneously. The stage cute (permeate flow/feed flow) was kept below 0.01 to prevent concentration polarization and ensure a constant driving force. The feed and permeate compositions are analyzed by means of a Perkin-Elmer gas chromatograph (GC) equipped with a HayeSep Q column. The GC was calibrated with gas mixtures to determine the component response factors and retention times. The separation factor can then be determined according to:

$$α = \frac{{y}_{A} / {y}_{B}}{{x}_{A} / {x}_{B}}$$

where x and y represent the feed and permeate side composition for CO₂ (represented by A) and CH₄ (represented by B). The mixed gas experiments are also conducted at 35° C. Plasticization of polymers by CO₂ is a slow polymer-relaxation phenomenon, the plasticization pressure depends on the experimental time scales used to measure permeation. Therefore to ensure consistency of the permeance/permeability data, permeance/permeability values and separation factors were collected after measuring for at least 8 h. For plasticization experiments, the CO₂/CH₄ was increased to the next pressure and the same procedure repeated.

### 5. Tensile Testing

The tensile testing using ASTM D882 was done on ½ inch wide strips 6 inch long after conditioning for 40 hours at 72 degree and 50 RH.

### 6. Preparation of Hollow Membrane Fibers

Hollow-fiber membranes were produced by an immersion precipitation spinning process as described in O. C. David, et al., Journal of Membrane Science, 2012, 419-420, 49-56; G. C. Kapantaidakis, G. H. Koops, Journal of Membrane Science, 2002, 204, 153-171; and K. K. Kopec, et al., Journal of Membrane Science, 2011, 369, 308-318. Precipitation of the polymer occurs because of the exchange of solvent (e.g. acetone or NMP) and non-solvent (water) in the polymer matrix. When the inflow of non-solvent (water) and the outflow of solvent reach a certain level, the polymer becomes insoluble. This results in a phase change (coagulation) of the polymer from liquid solution to solid phase, thereby forming the membrane structure.

During this process, the dope formulation is pumped through the orifice of a needle-in-orifice spinneret. The bore liquid—a mixture of solvent (NMP/acetone) and non-solvent (water)—is pumped through the needle of the spinneret. After a short residence time (typically 1-5 seconds) in air (referred to as the air gap) the fiber is immersed in a water bath and coagulation of the polymer takes place. After coagulation, the fiber is collected on a drum. FIG. 1 is a schematic representation of a hollow-fiber spinning setup. UV curing of the fiber can take place immediately after exiting the spinneret, after various residence times in the coagulation bath, or even after washing (removal of solvents in streaming water bath). The combinations of phase separation and crosslinking can be optimized for specific performance targets.

Typical spinning conditions for making hollow fiber membranes are described, as follows. For each example the actual conditions will be stated.

The viscosity of the dope solutions need to be between: 2,000 and 25,000 mPa.

The dope pump is a gear pump with the capacity to pump between 0.3 ml/min to 15 ml/min with 3 ml/min being a typical value.

The shell pump is a gear pump with the capacity to pump between 0.1 ml/min to 5 ml/min with 1 ml/min being a typical value.

The bore pump is a gear pump with the capacity to pump between 0.1 ml/min to 5 ml/min with 1 ml/min being a typical value.

The air-gap determines the evaporation time for the dope solvent, with longer times resulting in a higher skin thickness. For example, with the dope described here a gap of 20 inches may result in a skin thickness of 1.2 micron, whereas an airgap of 5 inches may bring this down to less than 0.5 micron.

The spinneret is a micro extrusion head able to extrude up to three different solvents or solutions simultaneously. It is configured using two hollow needles, one in the other, extruding the inner fluids, whereas the outer ring around them extrudes the third fluid. The needles and ring are constructed to prevent mixing of the fluids before they exit the spinneret. Typically, the spinneret can be fed with the fluids at a designated temperature at high pressure to provide a continuous and even flow of fluids.

The coagulation bath, contains 200 liter of tap water can be regulated from 2° C. to 800° C., but was kept at 45° C. The composition of this batch can be changed to include other solvents.

The wash batch contains 200 liter of tap water can be regulated from 2° C. to 80° C., but was also kept at 45° C.

The uptake roll has a circumference of 1 meter and the speed is regulated to match the spinning speed.

The continuous fibers can be cut to one meter lengths and removed from the uptake roll for additional washing. Solvents such a as NMP are slow to dissipate from the coagulated polymer and may take long wash cycles from 12 h to 64 h.

### 7. Determination of Gas Permeability of Hollow Fiber Membranes

The permeability of the hollow fiber membranes was determined by making small modules; as described in O. C. David, et al., Journal of Membrane Science, 2012, 419-420, 49-56; G. C. Kapantaidakis, G. H. Koops, Journal of Membrane Science, 2002, 204, 153-171; and K.K. Kopec, et al., Journal of Membrane Science, 2011, 369, 308-318; that can hold 1 to 10 fibers, with two fibers being typical. In this patent two fibers are used unless otherwise stated. These module fibers are 4 inches long and 400-600 microns in diameter, and are glued into small metal cylinders as shown in the figure below. This unit is then mounted into a small membrane chamber that is pressurized by the gas supply. This can be pure gases (for example CO₂ or CH₄) or a blend of gases. The gas pressure is accurately controlled and monitored. In the same fashion as with the flat sheet, these permeate gases are injected into a GC to allow monitoring of the permeate gas composition. The selectivity of the hollow fiber membrane can thus be determined.

In some cases the hollow fibers may have small pinholes that will negatively affect the selectivity. The common method of coating hollow fibers with polydimethylsiloxane (PDMS), using the Henis and Tripodi approach is used. A thin coating of a porous polymer like silicone rubber does not change the permeability of the membrane, but does plug the pinholes, providing the selectivity of the actual membrane polymer. The following procedure has been applied to the hollow fiber membranes discussed unless otherwise noted.

A 10% PDMS solution in hexane is allowed to pre-polymerize for 30 minutes, and then diluted to 2% solids with additional hexane. The fibers in the module are immersed for 10 seconds in the PDMS solution, air dried and then placed in an oven overnight at 65 C to allow PDMS crosslinking.

### 8. Verification of Crosslinking of Crosslinkable Cellulose Esters

In order to understand if cellulose acetate (CA)-based materials demonstrated improved performance in gas filtration applications due to crosslinking, RT-FTIR spectroscopic measurements were performed. These measurements monitored changes in the chemistry of uncured, functionalized crosslinkable cellulose ester films upon exposing them to a UV lamp that is thought to initiate crosslinking.

Infrared absorption features attributed to the molecules of interest in this study (crosslinkable cellulose ester, photoinitiator, and auxiliary substituent) are plotted in FIG. 1 before and after crosslinkable cellulose ester was exposed to UV light. It is of note that initially-present features disappear upon exposure to UV light whereas features that are not initially evident become clear after UV exposure. These spectral changes indicate that a chemical reaction occurs when the sample is exposed to UV light. As these spectral features are tracked as a function of time (FIG. 2a), they change very sharply and suddenly. It is this abrupt change (seen clearly in FIG. 2b) in the RT-FTIR time-trace, which occurs in concert with UV illumination of the sample, that is indicative of crosslinking. Since the sharp changes are present in features attributed to crosslinkable cellulose ester and auxiliary substituent, we conclude that all chemical species participate in the chemical reaction.

### 9. Verification of Crosslinking

In order to verify the crosslinkable cellulose esters crosslinked upon UV curing real-time analytical techniques including Fourier-transform infrared (RT-FTIR), rheology and dynamic mechanical measurements were performed. These measurements monitored changes in the chemistry of uncured, functionalized CA films upon exposing them to a UV lamp that is thought to initiate crosslinking. All of these techniques showed storing evidence of changes in behaviors that could be directly assigned to crosslinking, such as spectral changes, tensile property changes, and viscosity increases upon exposure to UV radiation. This data was complementary to the gel-fraction numbers that typically increased from 1-5% to >70% in both acetone and NMP upon curing.

Table 1 provides the compositions of Dopes 1-2 which were used to prepare films.

TABLE 1

| Dope # | CE (g) | Solvent |
|---|---|---|
| 1 | Eastman ™ CA- | 5 wt % NMP in |
| | 394-60S (12 g) | Acetone (84 g) |
| 2 | Ex 2 (12 g) | 5 wt % NMP in |
| | | Acetone (84 g) |

Table 2 provides the Films 1-2 which were prepared from Dopes 1-2. Films 1, 3, and 4 were UV cured to form crosslinks.

TABLE 2

| | Composition | | | Film | | GF |
|---|---|---|---|---|---|---|
| | Dope # | Photo. | Aux. Cross. | Thickness | GF | Acet. |
| Film # | (g) | (g) | (g) | (μm) | NMP (%) | (%) |
| 1 | 2 (96) | I184 (2) | EEEA (0.1) | 50 | 78 | 83 |
| 2 | 1 (96) | 0 | 0 | 50 | 0 | 0 |
| 3 | 2 (84) | I819 (4) | 0 | 55 | | |
| 4 | 2 (84) | I819 (4) | TEGDA (4) | 65 | | |

Table 3 provides the performance results of Films 1-2.

TABLE 3

| | P(N₂) | P(CO₂) | |
|---|---|---|---|
| Film # | (barrer, Temp. ° C.) | (barrer, Temp. ° C.) | S |
| 1 | 0.1, 23° C. | 3.4, 23° C. | 38 |
| 2 | 0.2, 23° C. | 6.9, 23° C. | 35 |

Table 4 shows the performance results for Film 3 in a mixed gas (50:50 CH₄:CO₂) permeability experiment, at 50° C. No significant changes in CO₂ permeability was observed until 50 barg total pressure of the mixed gas (or 25 barg partial pressure CO₂).

TABLE 4

| Feed Pressure | | |
|---|---|---|
| 50:50 CH₄:CO₂ | P(CO₂)@50° C. | Selectivity |
| (barg) | (barrer) | CO₂/CH₄ |
| 7.3 | 2.6 | 21.3 |
| 15 | 2.2 | 20.1 |
| 30 | 2.1 | 18.5 |
| 40 | 2.2 | 17.2 |
| 50 | 2.3 | 16.7 |

Table 5 shows the performance results for Film 4 in a mixed gas (50:50 CH₄:CO₂) permeability experiment, at 50° C. No significant changes in CO₂ permeability was observed until 50 barg total pressure of the mixed gas (or 25 barg partial pressure CO₂).

TABLE 5

| Feed Pressure | | |
|---|---|---|
| 50:50 CH₄:CO₂ | P(CO₂)@50° C. | Selectivity |
| (barg) | (barrer) | CO₂/CH₄ |
| 7.5 | 2.4 | 21.3 |
| 15.3 | 1.6 | 22.7 |
| 30 | 1.7 | 20.6 |
| 40.2 | 1.8 | 19 |
| 49.4 | 1.8 | 18.6 |

Table 6 shows that Film 1, which is crosslinked, is CO₂ plasticization resistant up to 20.0 barg of CO₂.

TABLE 6

| CO₂ | P(CO₂) |
|---|---|
| Pressure | @ 35° C. |
| (barg) | (barrer) |
| 5.0 | 3.45 |
| 8.0 | 5.00 |
| 10.0 | 4.65 |
| 13.0 | 4.15 |
| 15.0 | 5.24 |
| 18.0 | 4.57 |
| 20.0 | 5.47 |

Table 7 shows that Film 2, which is uncrosslinked, becomes plasticized at about 13.0 barg CO₂. The film is treated at up to 20.0 barg CO₂, and then the pressure is reduced back to 3.0 barg CO₂. Film 2 does not recover from CO₂ plasticization.

TABLE 7

| CO₂ | P(CO₂) |
|---|---|
| Pressure | @35° C. |
| (barg) | (barrer) |
| 3.0 | 2.55 |
| 5.0 | 2.19 |
| 8.0 | 2.57 |
| 10.0 | 2.42 |
| 13.0 | 2.88 |
| 15.0 | 3 |
| 18.0 | 3.69 |
| 20.0 | 4.34 |
| 18.0 | 4.92 |
| 15.0 | 4.65 |
| 13.0 | 4.54 |
| 10.0 | 4.59 |
| 8.0 | 4.71 |
| 5.0 | 4.99 |
| 3.0 | 5.02 |

The following additional films in Table 8 were prepared by adapting the procedures previously described. The first four films did not contain photoinitiator and were not UV cured. The other films contained photoinitiator (i.e., I184) and were UV cured. The dry film compositions for each film is provided.

TABLE 8

| | CE | | Dry film composition | | |
|---|---|---|---|---|---|
| Film | Ex # | XL | % Ex # | % PI | % XL |
| 5 | Eastman ™ | — | 100 | 0 | 0 |
| | CA 394 | | | | |
| 6 | 4 | — | 100 | 0 | 0 |
| 7 | Eastman ™ | — | 100 | 0 | 0 |
| | CAB 381-20 | | | | |
| 8 | 5 | — | 100 | 0 | 0 |
| 9 | 2 | — | 97 | 3 | 0 |
| 10 | 1 | — | 97 | 3 | 0 |
| 11 | 3 | — | 97 | 3 | 0 |
| 12 | 4 | — | 97 | 3 | 0 |
| 13 | 2 | TetraEGDA | 90.9 | 3 | 6.1 |
| 14 | 2 | P10EGDA | 74.4 | 3 | 22.9 |
| 15 | 3 | TetraEGDA | 91 | 3 | 5.9 |
| 16 | 4 | TetraEGDA | 78.5 | 3 | 18.5 |
| 17 | 2 | 2T | 93.3 | 3 | 3.7 |
| 18 | 4 | 2T | 84.9 | 3 | 12.1 |
| 19 | 6 | — | 100 | 0 | 0 |
| 20 | 6 | 2T | 92.9 | 3 | 6.8 |
| 21 | 7 | — | 100 | 0 | 0 |
| 22 | 1 | TetraEGDA | 88.1 | 3 | 8.9 |

Table 9 shows the single gas permeation results for Films 5, and 7-18. The last column shows the acetone gel fraction results. The nitrogen pressure was 20 bar and the films showed low permeability. The CO₂ pressure was 5 bar as at this low pressure plasticization was low. Films 5, and 7-8 completely dissolved [during the acetone gel fraction studies because they were not crosslinked].

TABLE 9

| | | P(N₂) | P(CO₂) | | |
|---|---|---|---|---|---|
| Film # | CE Ex # | 20 bar | 5 bar | Selectivity | GF |
| 5 | Eastman ™ CA 394 | 0.2 | 4.9 | 22.7 | |
| 6 | 4 | 2.1 | 18 | 8.6 | |
| 7 | Eastman ™CAB 381- | 2.2 | 37.1 | 16.7 | |
| | 20 | | | | |
| 8 | 5 | 2.49 | 42.8 | 17.2 | |
| 9 | 2 | 0.13 | 3.2 | 24.9 | 80 |
| 10 | 1 | 0.18 | 3.55 | 19.7 | 87 |
| 11 | 3 | 0.17 | 3.4 | 19.7 | |
| 12 | 4 | 1.2 | 22.8 | 19.4 | |
| 13 | 2 | 0.1 | 2.5 | 18.6 | 60 |
| 14 | 2 | 0.1 | 2.7 | 24.5 | 87 |
| 15 | 3 | 0.22 | 5.7 | 25.6 | |
| 16 | 4 | 0.36 | 7.9 | 22.3 | 93 |
| 17 | 2 | 0.1 | 2.8 | 28.3 | 91 |
| 18 | 4 | 0.3 | 12.6 | 43.8 | 97 |
| 19 | 6 | 3.8 | 61.0 | 15.9 | 0 |
| 20 | 6 | 2.5 | 43.6 | 17.4 | 95 |
| 21 | 7 | 10.8 | 162 | 15.1 | 0 |

For these experiments the feed was a (50:50) CO₂/CH₄ mixed gas composition with a feed and bleed mode, bleed >10× permeance, at a temperature of 50° C., a transmembrane pressure 4 or 40 bar. The membrane area is 12.5 cm² with a thickness of ±50 micron. A GC analysis of feed and permeate samples was once per hour.

TABLE 10
Mixed gas measurements

| | P CH₄ | | P CO₂ | | Selectivity | |
|---|---|---|---|---|---|---|
| Film # | 4 bar | 40 bar | 4 bar | 40 bar | 4 bar | 40 bar |
| 5 | 0.4 | 0.6 | 7.4 | 10.2 | 18.5 | 17.0 |
| 9 | 0.2 | 0.3 | 3.7 | 5.9 | 18.5 | 19.7 |
| 10 | 0.4 | 0.6 | 7 | 9 | 18 | 15.0 |
| 11 | 0.4 | 0.6 | 7.8 | 10.9 | 27.2 | 18.2 |
| 12 | 2.6 | 4.1 | 26 | 36 | 10 | 8.8 |
| 14 | 0.2 | 0.3 | 4 | 5.4 | 20 | 18.0 |
| 17 | 0.3 | 0.4 | 7.6 | 5.6 | 25.3 | 14.0 |
| 18 | 1.1 | 1.6 | 13.7 | 19.5 | 17.7 | 12.2 |

### Plasticization Resistance Studies

One way to measure the plasticization resistance, PZR, is as the change in CO₂ permeability calculated as the relative change in permeability at 20 bar compared to 5 bar as calculated in the equation below:

$$PZR = \frac{( {P}_{CO 2 , 20 bar} - {P}_{CO 2 , 5 bar} )}{{P}_{CO 2 , 5 bar}} * 100$$

The examples below show the reduction on PZR of the crosslinked CAX polymers vs. the cellulose diacetate.

TABLE 11

| | P(N2) | P(CO2) | P(CO2)− | Selectivity | |
|---|---|---|---|---|---|
| Film # | 5 Bar | 5 Bar | 20 Bar | @5 Bar | PZR |
| 5 | 0.2 | 4.9 | 6.9 | 24.5 | 40.8 |
| 9 | 0.2 | 3.6 | 3.8 | 18.0 | 5.6 |
| 22 | 0.2 | 5.2 | 6.4 | 26.0 | 23.1 |
| 18 | 0.3 | 12.6 | 13.3 | 42.0 | 5.6 |

Table 12 provides the compositions for Dopes 3-4 which were used to prepare hollow fiber membranes.

TABLE 12

| | | Photo. | Aux. | |
|---|---|---|---|---|
| Dope # | CE (g) | (g) | Cross. (g) | Solvent |
| 3 | Ex 2 | I184 | — | Acetone (17.6 g), |
| | (23.5) | (1.2) | | NMP (53 g), |
| | | | | Water (4.7 g) |
| 4 | Ex 2 | I184 | TEGDA | Acetone (17.9 g), |
| | (23.8 g) | (1.2) | (3.5) | NMP (48.8 g), |
| | | | | Water (4.8 g) |

Table 13 provides the performance results of HFM 1-2.

TABLE 13

| | | P(CO₂) | |
|---|---|---|---|
| | Prepared | (barrer, | |
| HFM # | from Dope # | Temp, ° C.) | S |
| 1 | 3 | 6, ~21° C. | 32 |
| 2 | 4 | 6, ~21° C. | 33 |

### Illustrative Examples of Inventive Concepts

While Applicant's disclosure includes reference to specific implementations above, it will be understood that modifications and alterations may be made by those practiced in the art without departing from the spirit and scope of the inventive concepts described herein. All such modifications and alterations are intended to be covered. As such the illustrative examples of the inventive concepts listed below are merely illustrative and not limiting.

### Embodiment 1

A membrane comprising:
(a) a crosslinkable cellulose ester comprising:
   (i) a plurality of an (C₂₋₂₀)alkanoyl substituent;
   (ii) a plurality of a crosslinkable substituent; and
   (iii) a plurality of hydroxyl groups,
wherein the degree of substitution of the (C₂₋₂₀)alkanoyl substituent (“DS_{Ak}”) is in the range of from about 0 to about 2.8,
wherein the degree of substitution of the crosslinkable substituent (“DS_{CS}”) is in the range of from about 0.01 to about 2.0,
wherein the degree of substitution of the hydroxyl substituent (“DS_{OH}”) is in the range of from about 0.1 to about 1.0, and
wherein the cellulose ester has a number average molecular weight (“Mₙ”) in the range of from about 5,000 Da to about 110,000 Da; and
wherein the membrane comprises at least some crosslinks.

### Embodiment 2

The membrane of Embodiment 1, wherein the crosslinkable substituent comprises 1-2 of an alkenyl, an alkynyl, a thiol, or an acrylate group.

### Embodiment 3

The membrane of any one of Embodiments 1 or 2, wherein the crosslinkable substituent is chosen from maleate, crotonate, 2-(3-(prop-1-en-2-yl)phenyl)propan-2-yl)carbamoate, undec-10-enoate, hex-5-enoate, hept-6-enoate, oct-7-enoate, non-8-enoate, dec-9-enoate, or dodec-11-enoate.

### Embodiment 4

The membrane of Embodiment 3, wherein the crosslinkable substituent is undec-10-enoate.

### Embodiment 5

The membrane of any one of Embodiments 1-4, wherein the composition further comprises (b) an auxiliary crosslinker, wherein the auxiliary crosslinker is present from about 0.01 to about 25.0 wt % based on the total weight of the dry crosslinked membrane.

### Embodiment 6

The membrane of Embodiment 5, wherein the auxiliary crosslinker comprises 1-4 of an alkenyl, an alkynyl, a thiol, or an acrylate group.

### Embodiment 7

The membrane of Embodiment 5, wherein the auxiliary crosslinker is

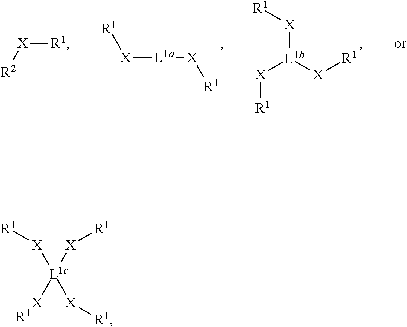

wherein

each R¹ is independently
(1)

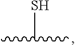 [SMILES: *S]

(2)

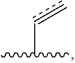

(3)

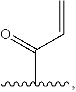 [SMILES: *C(=O)C=C]

or
(4)

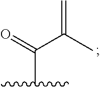 [SMILES: *C(=O)C(=C)C]

R² is
(1) (C₁₋₂₀)alkyl,
(2) R⁵—[—O—(C₁₋₆)alkyl-O—]ₙ—, wherein n is 0-2000, and wherein R⁵ is hydrogen or (C₁₋₃)alkyl;

each X is independently absent, —O—, or —OCH₂—;

L^{1a} is
(1) —O—(C₁₋₂₀)alkyl-O—,
(2) —[—O—(C₁₋₆)alkyl-O—]ₙ—, wherein n is 0-2000,
(3)

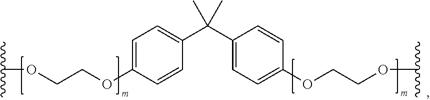

wherein each m is independently 0-100;

L^{1b} is
(1)

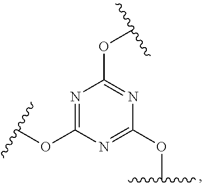 [SMILES: *Oc1nc(O*)nc(O*)n1]

(2)

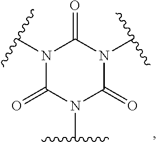 [SMILES: *n1c(=O)n(*)c(=O)n(*)c1=O]

(3)

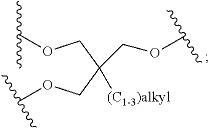

and

L^{1c} is

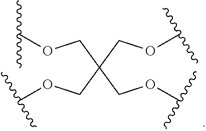 [SMILES: *OCC(CO*)(CO*)CO*]

### Embodiment 8

The membrane of Embodiment 7, wherein the auxiliary crosslinker is chosen from 2-(2-ethoxyethoxy)ethylacrylate, triethylene glycol diacrylate, tetraethylene glycol diacrylate, poly(C10)ethylene glycol diacrylate, or 2,2′-(ethylenedioxy)diethanethiol.

### Embodiment 9

The membrane of any one of Embodiments 1-8, wherein the (C₂₋₂₀)alkanoyl substituents are chosen from acetyl, propionyl, n-butyryl, isobutyryl, pivaloyl, 2-methylbutanoyl, 3-methylbutanoyl, pentanoyl, 2-methylpentanoyl, 3-methylpentanoyl, 4-methylpentanoyl, hexanoyl, palmitoyl, lauryl, decanoyl, undecanoyl, or a fatty acid derived substituent.

### Embodiment 10

The membrane of Embodiment 9, wherein the (C₂₋₂₀)alkanoyl substituent is chosen from acetyl, propionyl, or n-butyryl.

### Embodiment 11

The membrane of any one of Embodiments 1-10, wherein the Mₙ is in the range of from about 20,000 Da to about 60,000 Da.

### Embodiment 12

The membrane of any one of Embodiments 1-11, wherein the membrane is an asymmetric membrane comprising a first porous layer and a second porous layer.

### Embodiment 13

The membrane of any one of Embodiments 1-12, wherein the membrane is a hollow fiber membrane.

### Embodiment 14

The membrane of any one of Embodiments 1-13, wherein the membrane is not crosslinked.

### Embodiment 15

The membrane of any one of Embodiments 1-14, wherein the membrane has a pure gas carbon dioxide permeability (“P(CO₂)”) in the range of from about 2 barrer to about 200 barrer measured at 50° C.

### Embodiment 16

The membrane of any one of Embodiments 1-15, wherein the membrane has a pure gas nitrogen permeability (“P(N₂)”) or a pure gas methane permeability (“P(CH₄)”) less than 20 barrer measured at 50° C.

### Embodiment 17

The membrane of any one of Embodiments 1-16, wherein the membrane has a carbon dioxide permeability (“P(CO₂)”) in the range of from about 2 barrer to about 200 barrer and a methane permeability (“P(CH₄)”) less than 100 barrer as measured with a 50:50 carbon dioxide/methane blend at 50° C.

### Embodiment 18

The membrane of any one of Embodiments 1-17, wherein the membrane satisfies the following expression:

$$\frac{( {P ( CO 2 )}_{20 bar} - {P ( CO 2 )}_{5 bar} )}{{P}_{{CO}_{2 , 5 bar}}} * 100 < 50$$

P(CO₂)_{20bar}=carbon dioxide permeability at 20 bar measured at 50° C.
P(CO₂)_{5bar}=carbon dioxide permeability at 5 bar measured at 50° C.

### Embodiment 19

The membrane of any one of Embodiments 1-18, wherein the membrane has a carbon dioxide/nitrogen gas or carbon dioxide/methane selectivity greater than 10 as measured at 50° C. in pure CO₂, N₂ and CH₄ gas streams at 4 bar.

### Embodiment 20

The membrane of any one of Embodiments 1-19, wherein the membrane has a carbon dioxide/nitrogen gas selectivity greater than 10 as measured at 50° C. in pure nitrogen gas stream of 20 bar and a pure carbon dioxide gas stream of 5 bar.

### Embodiment 21

The membrane of any one of Embodiments 1-20, wherein the membrane has a carbon dioxide/methane selectivity greater than 10 as measured at 50° C. in a 50:50 mixed gas stream of carbon dioxide/methane at 4 bar.

### Embodiment 22

The membrane of any one of Embodiments 1-21, wherein the membrane has a carbon dioxide/methane selectivity greater than 9 as measured at 50° C. in a 50:50 mixed gas stream of carbon dioxide/methane at 40 bar.

What is claimed is:

1. A membrane comprising:
(a) a crosslinkable cellulose ester comprising:
(i) a plurality of an (C₂₋₂₀)alkanoyl substituent;
(ii) a plurality of a crosslinkable substituent; and
(iii) a plurality of hydroxyl groups,
wherein the degree of substitution of the (C₂₋₂₀)alkanoyl substituent (“DS_{Ak}”) is in the range of from about 0 to about 2.8,
wherein the degree of substitution of the crosslinkable substituent (“DS_{CS}”) is in the range of from about 0.01 to about 2.0,
wherein the degree of substitution of the hydroxyl substituent (“DS_{OH}”) is in the range of from about 0.1 to about 1.0, and
wherein the cellulose ester has a number average molecular weight (“Mₙ”) in the range of from about 5,000 Da to about 110,000 Da; and
wherein the membrane comprises at least some crosslinks.

2. The membrane of claim 1, wherein the crosslinkable substituent comprises 1-2 of an alkenyl, an alkynyl, a thiol, or an acrylate group.

3. The membrane of claim 2, wherein the crosslinkable substituent is chosen from maleate, crotonate, 2-(3-(prop-1-en-2-yl)phenyl)propan-2-yl)carbamoate, undec-10-enoate, hex-5-enoate, hept-6-enoate, oct-7-enoate, non-8-enoate, dec-9-enoate, or dodec-11-enoate.

4. The membrane of claim 1, wherein the membrane further comprises (b) an auxiliary crosslinker, wherein the auxiliary crosslinker is present in the crosslinked membrane from about 0.01 to about 50.0 wt % based on the total weight of the crosslinkable cellulose ester and the auxiliary crosslinker.

5. The membrane of claim 4, wherein the auxiliary crosslinker comprises 1-4 of an alkenyl, an alkynyl, a thiol, or an acrylate group.

6. The membrane of claim 4, wherein the auxiliary crosslinker is 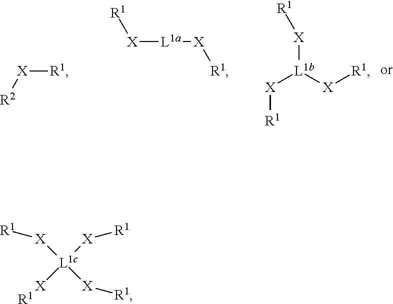
wherein
each R¹ is independently
(1) 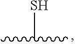 [SMILES: *S]
(2) 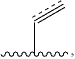
(3) 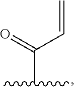 [SMILES: *C(=O)C=C]
or
(4) 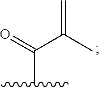 [SMILES: *C(=O)C(=C)C]
R² is
(1) (C₁₋₂₀)alkyl,
(2) R⁵—[—O—(C₁₋₆)alkyl-O—]ₙ—, wherein n is 0-2000, and wherein R⁵ is hydrogen or (C₁₋₃)alkyl;
each X is independently absent, —O—, or —OCH₂—;
L^{1a} is
(1) —O—(C₁₋₂₀)alkyl-O—,
(2) —[—O—(C₁₋₆)alkyl-O—]ₙ—, wherein n is 0-2000,
(3) 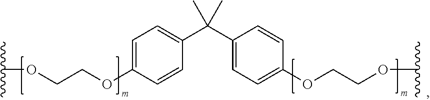
wherein each m is independently 0-100;
L^{1b} is
(1), 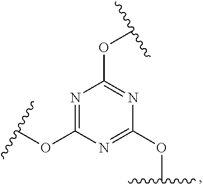 [SMILES: *Oc1nc(O*)nc(O*)n1]
(2) 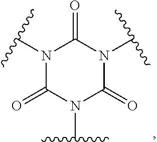 [SMILES: *n1c(=O)n(*)c(=O)n(*)c1=O]
(3) 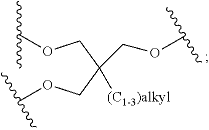
and
L^{1c} is

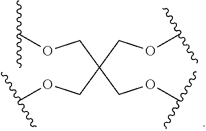 [SMILES: *OCC(CO*)(CO*)CO*]

7. The membrane of claim 6, wherein the auxiliary crosslinker is chosen from 2-(2-ethoxyethoxy)ethylacrylate, triethylene glycol diacrylate, tetraethylene glycol diacrylate, poly(C10)ethylene glycol diacrylate, or 2,2′-(ethylenedioxy)diethanethiol.

8. The membrane of claim 1, wherein the (C₂₋₂₀)alkanoyl substituents are chosen from acetyl, propionyl, n-butyryl, isobutyryl, pivaloyl, 2-methylbutanoyl, 3-methylbutanoyl, pentanoyl, 2-methylpentanoyl, 3-methylpentanoyl, 4-methylpentanoyl, hexanoyl, palmitoyl, lauryl, decanoyl, undecanoyl, or a fatty acid derived substituent.

9. The membrane of claim 8, wherein the (C₂₋₂₀)alkanoyl substituent is chosen from acetyl, propionyl, or n-butyryl.

10. The membrane of claim 1, wherein the Mₙ is in the range of from about 20,000 Da to about 60,000 Da.

11. The membrane of claim 1, wherein the membrane is an asymmetric membrane comprising a first porous layer and a second porous layer.

12. The membrane of claim 1, wherein the membrane is a hollow fiber membrane.

13. The membrane of claim 1, wherein the membrane is not crosslinked.

14. The membrane of claim 1, wherein the membrane has a pure gas carbon dioxide permeability (“P(CO₂)”) in the range of from about 2 barrer to about 200 barrer measured at 50° C.

15. The membrane of claim 14, wherein the membrane has a pure gas nitrogen permeability (“P(N₂)”) or a pure gas methane permeability (“P(CH₄)”) less than 20 barrer measured at 50° C.

16. The membrane of claim 15, wherein the membrane has a carbon dioxide permeability (“P(CO₂)”) in the range of from about 2 barrer to about 200 barrer and a methane permeability (“P(CH₄)”) less than 100 barrer as measured with a 50:50 carbon dioxide/methane blend at 50° C.

17. The membrane of claim 1, wherein the membrane satisfies the following expression:
$$\frac{( {P ( CO 2 )}_{20 bar} - {P ( CO 2 )}_{5 bar} )}{{P}_{{CO}_{2 , 5 bar}}} * 100 < 50$$
P(CO₂)_{20bar}=carbon dioxide permeability at 20 bar measured at 50° C.
P(CO₂)_{5bar}=carbon dioxide permeability at 5 bar measured at 50° C.

18. The membrane of claim 1, wherein the membrane has a carbon dioxide/nitrogen gas or carbon dioxide/methane selectivity greater than 10 as measured at 50° C. in pure CO₂, N₂ and CH₄ gas streams at 4 bar.

19. The membrane of claim 1, wherein the membrane has a carbon dioxide/nitrogen gas selectivity greater than 10 as measured at 50° C. in pure nitrogen gas stream of 20 bar and a pure carbon dioxide gas stream of 5 bar.

20. The membrane of claim 1, wherein the membrane has a carbon dioxide/methane selectivity greater than 10 as measured at 50° C. in a 50:50 mixed gas stream of carbon dioxide/methane at 4 bar.

21. The membrane of claim 1, wherein the membrane has a carbon dioxide/methane selectivity greater than 9 as measured at 50° C. in a 50:50 mixed gas stream of carbon dioxide/methane at 40 bar.
